(19) United States
(12) Patent Application Publication
(10) Pub. No.: US 2023/0069625 A1
(43) Pub. Date: Mar. 2, 2023

(54) DELIVERY SYSTEM

(71) Applicant: LG ELECTRONICS INC., Seoul (KR)

(72) Inventors: Donghoon YI, Seoul (KR); Kyungho YOO, Seoul (KR); Byungki KIM, Seoul (KR)

(73) Assignee: LG ELECTRONICS INC., Seoul (KR)

(21) Appl. No.: 17/670,058

(22) Filed: Feb. 11, 2022

(30) Foreign Application Priority Data
Aug. 24, 2021 (KR) 10-2021-0111805
Oct. 12, 2021 (KR) PCT/KR2021/014033

(51) Int. Cl. G05D 1/02; G05D 1/00

(52) U.S. Cl. CPC G05D 1/0225; G05D 1/0219; G05D 1/0088; G05D 1/0022; G05D 1/0027; G05D 2201/0216

(57) ABSTRACT

A delivery robot can include a communication transceiver configured to communicate with a control server; one or more sensors configured to sense information related to a state of the delivery robot; at least one camera configured to capture an image of surroundings of the delivery robot; a drive part configured to move a main body of the delivery robot; and a controller configured to receive address information of an address location from the control server to drive while searching for the address location in a building corresponding to the address location based on the address information, and generate path information to the address location based on at least one of the address information, a driving path while searching for the address location, a sensing result of the one or more sensors and the image captured by the at least one camera.

### CROSS-REFERENCE TO RELATED APPLICATIONS

Pursuant to 35 U.S.C. § 119(a), this application claims priority to Korean Patent Application No. 10-2021-0111805, filed on Aug. 24, 2021 in the Republic of Korea, and International Patent Application No. PCT/KR2021/014033, filed on Oct. 12, 2021, the entire contents of all these applications are incorporated by reference into the present application.

### BACKGROUND

### 1. Technical Field

The present disclosure relates to a delivery system in which a delivery robot delivers products while autonomously driving in a driving region.

### 2. Description of the Related Art

Competition for transporting products in online and offline markets is heating up day by day, and a service of transporting products on the day of purchasing the products is sometimes provided in order to provide better convenience to a user.

In recent years, unmanned mobile robots for transporting products have been applied on the ground or in the air, and related laws and regulations are gradually being prepared.

A robot may be a machine that automatically processes or operates a task given by its own capabilities. In particular, a robot having a function of recognizing an environment and performing an operation based on self-determination may be referred to as an intelligent robot, and various services may be provided using the intelligent robot.

On the other hand, a delivery system using a robot requires information such as a map, a path, and the like of the driving region in order to provide a delivery service on the driving region. Only when such information is accumulated, a service is established to allow the robot to deliver the products to a destination.

However, it is not easy to set a delivery destination in advance, and a process of generating map information, and path information required for service establishment in advance in the driving region including outdoors and outdoors also consumes a lot of time and money, and an advance service establishment task itself has a difficult limitation. Accordingly, it is difficult not only to drive itself in a driving region in which a service is not established or to an address location where path information is not generated, but also to initially drive to such an area, and the fundamental limitation has not been resolved as the driving limitation to the address location where path information does not exist has not been resolved.

### SUMMARY OF THE DISCLOSURE

The present disclosure is directed to providing embodiments capable of improving limitations in the related art as described above.

Specifically, an aspect of the present disclosure is to provide embodiments of a delivery robot capable of driving to an address location where path information is not generated, a delivery robot system, and a driving method of the delivery robot.

Furthermore, another aspect of the present disclosure is to provide embodiments of a delivery robot capable of generating path information by performing search driving for an address location where path information is not generated, a delivery robot system, and a driving method of the delivery robot.

In addition, still another aspect of the present disclosure is to provide embodiments of a delivery robot capable of establishing a service by generating path information and map information while at the same time performing initial driving without establishing map information or service in advance, a delivery robot system, and a driving method of the delivery robot.

Moreover, yet still another aspect of the present disclosure is to provide embodiments of a delivery robot capable of quickly performing search driving to an address location using destination information, a delivery robot system, and a driving method of the delivery robot.

An embodiment of the present disclosure for solving the above-described problem is characterized in that a delivery robot performs search driving within a building at a destination address location to generate path information based on a result of the search driving.

More specifically, based on address information of the destination address location, search driving is performed inside the building at the relevant address based on Vision AI to generate path information based on a driving path of the search driving and a result of photographing recognition while driving.

The foregoing technical features may be applied and implemented to one or more of a mobile robot, a driving robot, an artificial intelligence robot, a system of such a robot, a service system, a driving system, a driving method, a control method, and a service system and method using such a robot, and an object of the present disclosure is to provide embodiments of a delivery robot, a delivery system, and a driving method of the delivery robot having the foregoing technical features as a problem solving means.

An embodiment of a delivery robot having the foregoing technical features as a problem solving means, as a delivery robot that drives in one or more of an outdoor region and an indoor region, may include a communication unit that communicates with a control server that controls the delivery robot, a sensing unit that senses one or more pieces of information related to a state of the delivery robot, a photographing unit that photographs the surroundings of the delivery robot, a drive unit that moves a main body of the delivery robot, and a controller that controls one or more of the communication unit, the sensing unit, the photographing unit, and the drive unit to control an operation of the delivery robot, in which when moving to an address location where path information is not generated among address locations in the indoor region, the controller receives address information of the address location from the control server to drive while searching for the address location in a building corresponding to the address location based on the address information, and generates path information to the address location based on the address information, a driving path while searching for the address location, a sensing result of the sensing unit and a photographing result of the photographing unit.

According to an embodiment, the address information may include identification information of the address location, location information of a building corresponding to the address location, and region information on an region of the building.

According to an embodiment, when moving from a location other than the building to the address location, the controller may control the delivery robot to move to the building based on the location information.

According to an embodiment, when moving from an outside of the building to an inside of the building, the controller may control the delivery robot to enter an entrance of the building while moving below a preset reference speed.

According to an embodiment, the reference speed may be set to be below a speed when driving in the outdoor region.

According to an embodiment, the controller may control the delivery robot to drive in a region of the building according to the region information.

According to an embodiment, the controller may recognize a floor of the address location based on the identification information to move to the recognized floor, and then control a location corresponding to the identification information to be searched for based on one or more of the sensing result of the sensing unit and the photographing result of the photographing unit.

According to an embodiment, the identification information may include information on the floor and number of the address location.

According to an embodiment, the controller may recognize an identification tag attached to a door or a periphery of the address location by one or more of the sensing unit and the photographing unit to control a location corresponding to the identification information to be searched for.

According to an embodiment, when moving to the floor of the address location, the controller may search for mobile equipment provided in the building using a photographing result of the photographing unit to control the delivery robot to move to the floor of the address location through the mobile equipment.

According to an embodiment, the mobile equipment may include at least one of an escalator and an elevator.

According to an embodiment, when moving through the mobile equipment, the controller may control the delivery robot to ride on the mobile equipment according to a preset operation reference and to operate according to the operation reference while moving through the mobile equipment.

According to an embodiment, the controller may analyze one or more movement paths to the address location based on the address information, the driving path, the sensing result, and the photographing result, and generate the path information according to the analysis result.

According to an embodiment, the path information may include at least one of a shortest distance path from the entrance of the building to the address location and a shortest time path from the entrance door of the building to the address location.

According to an embodiment, the controller may further generate structure information on each floor structure of the building based on the address information, the driving path, the sensing result, and the photographing result.

According to an embodiment, the controller may generate map information of the building based on the path information and the structure information, or update previously generated map information.

On the other hand, an embodiment of a delivery system having the foregoing technical features as a problem solving means, as a delivery system in which products are delivered in a driving region including one or more of an outdoor region and an indoor region, may include a control server that controls the delivery system, a communication device that communicates with a plurality of communication targets in the driving region, and a delivery robot that performs delivery while driving in the driving region according to communication with the control server and the communication device, in which the delivery robot receives address information of an address location where path information is not stored from the control server to move to a building corresponding to the address location based on the address information, receives search information on the address location from one or more of the control server and the communication device to drive while searching for the address location in the building based on the address information and the search information, and generates path information of the address location based on the driving result to perform one or more of storing the path information and transmitting the path information to the control server.

According to an embodiment, the delivery robot may generate structure information of the building based on the search information to drive in the building based on the address information and the structure information.

According to an embodiment, the communication device may be a control device that centrally controls energy use equipment provided in the building, and the identification information may include information on installation information of the energy use equipment.

According to an embodiment, the communication device may be a communication server communicably connected to communication equipment provided in the building, and the search information may include installation information of the communication equipment.

According to an embodiment, the communication device may be a central server of one or more of a construction company and a management company of the building, and the search information may include design information of the building.

According to an embodiment, the communication device may be a central server of a user company of the building, and the search information may include guide information of the building.

In addition, another embodiment of a delivery system having the foregoing technical features as a problem solving means, as a delivery system in which products are delivered in a driving region including one or more of an outdoor region and an indoor region, may include a control server that controls the delivery system, a communication device that communicates with a plurality of communication targets in the driving region, and a delivery robot that performs delivery while driving in the driving region according to communication with the control server and the communication device, in which the delivery robot receives address information of an address location where path information is not stored and structure information of a building corresponding to the address location from the control server to move to the building corresponding to the address location based on the address information, and drives while searching for the address location in the building based on the address information and the structure information, and generates path information of the address location based on the driving result to perform one or more of storing the path information and transmitting the path information to the control server.

According to an embodiment, the control server may receive search information on the address location from one or more of the communication device and the delivery robot to generate the structure information based on the search information, and to transmit the structure information to the delivery robot.

According to an embodiment, the communication device may be a control device that centrally controls energy use equipment provided in the building, and the identification information may include installation information of the energy use equipment.

According to an embodiment, the communication device may be a communication server communicably connected to communication equipment provided in the building, and the search information may include installation information of the communication equipment.

According to an embodiment, the communication device may be a central server of one or more of a construction company and a management company of the building, and the search information may include design information of the building.

According to an embodiment, the communication device may be a central server of a user company of the building, and the search information may include guide information of the building.

On the other hand, an embodiment of a driving method of a delivery robot having the foregoing technical features as a problem solving means, as a driving method of a delivery robot that drives in a driving region comprising one or more of an outdoor region and an indoor region, may include receiving identification information of an address location where path information is not generated, location information of a building corresponding to the address location, and region information on a region of the building from a control server that controls the delivery robot, moving to a building corresponding to the address location based on the location information, entering the building through an entrance of the building based on a preset speed, searching for a location corresponding to the identification information while driving in the building according to the region information, and generating path information to the address location based on the identification information, a driving path during the moving step to the searching step, a sensing result of sensing the surroundings of the driving path, and a photographing result of photographing the surroundings of the driving path.

In addition, another embodiment of a driving method of a delivery robot having the foregoing technical features as a problem solving means, as a delivery robot that drives in a driving region comprising one or more of an outdoor region and an indoor region, may include receiving address information of an address location where path information is not generated and structure information of a building corresponding to the address location from one or more of a control server that controls the delivery robot and a communication device that performs communication in the driving region, moving to the building based on the address information, entering the building through an entrance of the building based on a preset speed, searching for a location corresponding to the address location while driving in the building based on the address information and the structure information, and generating path information to the address location based on the address information, a driving path during the moving step to the searching step, a sensing result of sensing the surroundings of the driving path, and a photographing result of photographing the surroundings of the driving path.

According to the foregoing embodiments of a delivery robot, a delivery system, and a driving method of the delivery robot, each embodiment may be implemented independently, a plurality of the embodiments may be implemented in combination, parts of each of the plurality of embodiments may be implemented in combination, and one or more embodiments may be implemented in a modified form in combination with other embodiments.

The foregoing embodiments of a delivery robot, a delivery system, and a driving method of the delivery robot may be applied and implemented to a mobile robot, an autonomous driving robot, an artificial intelligence robot, a system of such a robot, a control method, a driving method, and the like, and in particular, may be usefully applied and implemented to an artificial intelligence delivery robot that drives in outdoor and indoor regions, a system including the same, and a delivery method of the system. In addition, the foregoing embodiments may be applied and implemented to all robots, robot systems, robot control methods, and robot driving methods to which the technical concept of the above technology can be applied.

According to the embodiments of a delivery robot, a delivery system, and a driving method of the delivery robot to be provided in the present disclosure, based on address information of a destination address location, search driving may be performed inside the building at the relevant address location based on Vision AI to generate path information based on a driving path of the search driving and a result of photographing recognition while driving, thereby allowing initial driving to be performed to an address location where path information is not generated.

Accordingly, there is an effect capable of establishing a service by generating path information and map information while at the same time performing initial driving without establishing map information or service in advance.

In addition, there is an effect capable of quickly performing search driving to an address location using destination information, thereby reducing time, cost, and data throughput consumed for service establishment and map preparation.

As a result, the embodiments of a delivery robot, a delivery system, and a driving method of the delivery robot provided herein have an effect capable of improving limitations in the related art, as well as increasing efficiency, reliability, effectiveness, and usefulness in the technical field of the delivery robot.

### BRIEF DESCRIPTION OF THE DRAWINGS

FIG. 1 is a block diagram of a delivery system according to an embodiment of the present disclosure.

FIG. 2A is an example view 1-a showing an example of a driving region according to an embodiment of the present disclosure.

FIG. 2B is an example view 1-b showing an example of a driving region according to an embodiment of the present disclosure.

FIG. 3A is an example view 2-a showing an example of a driving region according to an embodiment of the present disclosure.

FIG. 3B is an example view 2-b showing an example of a driving region according to an embodiment of the present disclosure.

FIG. 4 is an example view 3 showing an example of a driving region according to an embodiment of the present disclosure.

FIG. 5 is an example view showing an external configuration of a delivery robot according to an embodiment of the present disclosure.

FIG. 6 is an example view showing an internal configuration of a delivery robot according to an embodiment of the present disclosure.

FIG. 7A is an example view a showing an example of setting a movement path of a delivery robot according to an embodiment of the present disclosure.

FIG. 7B is an example view b showing an example of setting the movement path of the delivery robot according to an embodiment of the present disclosure.

FIG. 8 is an example view showing an illustration of an operation sequence of a delivery system according to an embodiment.

FIG. 9 is an example view showing an illustration of movement of a delivery robot according to an embodiment.

FIG. 10 is a flowchart illustrating a sequence of delivery driving of a delivery robot according to an embodiment.

FIGS. 11A and 11B are example views showing an illustration of installation information according to an embodiment.

FIGS. 12A and 12B are example views showing an illustration of design information according to an embodiment.

FIG. 13 is an example view showing an illustration of guide information according to an embodiment.

FIG. 14 is a flowchart 1 showing a driving method of a delivery robot according to an embodiment.

FIG. 15 is a flowchart 2 showing a driving method of a delivery robot according to an embodiment.

### DETAILED DESCRIPTION OF THE EMBODIMENTS

Hereinafter, the embodiments disclosed in the present disclosure will be described in detail with reference to the accompanying drawings, and the same or similar elements are designated with the same numeral references regardless of the numerals in the drawings and their redundant description will be omitted. In describing the embodiments disclosed herein, moreover, the detailed description will be omitted when specific description for publicly known technologies to which the invention pertains is judged to obscure the gist of the present disclosure.

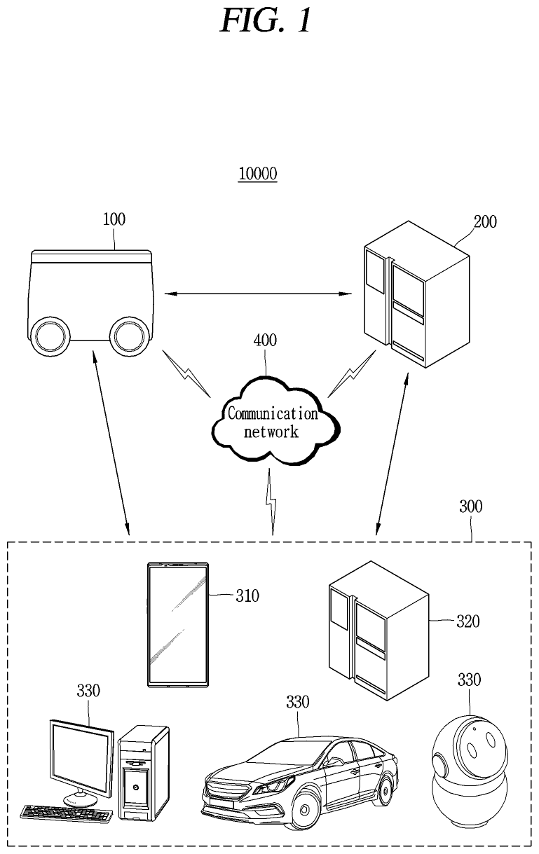

As illustrated in FIG. 1, the delivery system 10000 includes a delivery robot 100 that autonomously drives in a driving region, and a control server 200 communicably connected to the delivery robot 100 through a communication network 400 to control the operation of the delivery robot 100. Furthermore, the delivery system 10000 may further include one or more communication devices 300 communicatively connected to at least one of the delivery robot 100 and the control server 200 to transmit and receive information to and from at least one of the delivery robot 100 and the control server 200.

The delivery robot 100 may be an intelligent robot that automatically processes or operates a task given by its own capabilities. For example, the intelligent robot may be an automated guided vehicle (AGV), which is a transportation device that moves by a sensor on the floor, a magnetic field, a vision device, and the like, or a guide robot that provides guide information to a user in an airport, a shopping mall, a hotel, or the like.

The delivery robot 100 may be provided with a drive unit including an actuator or a motor to perform various physical operations such as moving a robot joint. For instance, the delivery robot 100 may autonomously drive in the driving region. The autonomous driving refers to a self-driving technology, and the delivery robot 100 may be an autonomous driving vehicle (robot) that is driven without a user's manipulation or with a user's minimal manipulation. A technology for maintaining a driving lane, a technology for automatically adjusting speed such as adaptive cruise control, a technology for automatically driving along a predetermined path, a technology for automatically setting a path when a destination is set, and the like may be all included in the autonomous driving.

In order to perform such autonomous driving, the delivery robot 100 may be a robot to which artificial intelligence (AI) and/or machine learning is applied. The delivery robot 100 may autonomously drive in the driving region to perform various operations through the artificial intelligence and/or machine learning. For instance, an operation according to a command designated from the control server 200 may be performed, or a self-search/monitoring operation may be performed.

A detailed description of artificial intelligence and/or machine learning technology applied to the delivery robot 100 is as follows.

Artificial intelligence (AI) refers to a field of studying artificial intelligence or a methodology capable of creating artificial intelligence, and machine learning refers to a field of studying a methodology for defining various problems dealt with in the field of artificial intelligence and solves them. The machine learning technology is a technology that collects and learns a large amount of information based on at least one algorithm, and determines and predicts information based on the learned information. The learning of information refers to an operation of recognizing the features of information, rules and determination criteria, quantifying a relation between information and information, and predicting new data using the quantified patterns. Machine learning is also defined as an algorithm that improves the performance of a certain task through continuous experience in the task.

Algorithms used by the machine learning technology may be algorithms based on statistics, for example, a decision tree that uses a tree structure type as a prediction model, an artificial neural network that mimics neural network structures and functions of living creatures, genetic programming based on biological evolutionary algorithms, clustering of distributing observed examples to a subset of clusters, a Monte Carlo method of computing function values as probability using randomly-extracted random numbers, and the like. As one field of the machine learning technology, there is a deep learning technology of performing at least one of learning, determining, and processing information using the artificial neural network algorithm.

An artificial neural network (ANN) as a model used in machine learning may refer to all of models having a problem-solving ability, which are composed of artificial neurons (nodes) that form a network by synaptic connections. The artificial neural network may have a structure of connecting between layers and transferring data between the layers. The deep learning technology may be employed to learn a vast amount of information through the artificial neural network using a graphic processing unit (GPU) optimized for parallel computing.

The artificial neural network may be defined by a connection pattern between neurons in different layers, a learning process of updating model parameters, and an activation function of generating an output value. The artificial neural network may include an input layer, an output layer, and optionally one or more hidden layers. Each layer may include one or more neurons, and the artificial neural network may include a synapse that connects neurons to neurons. In the artificial neural network, each neuron may output a function value of an activation function for input signals being input through the synapse, a weight, a bias, and the like. The model parameters refer to parameters determined through learning, and include a weight of a synaptic connection, a bias of a neuron, and the like. In addition, a hyperparameter refers to a parameter that must be set prior to learning in a machine learning algorithm, and includes a learning rate, a repetition number, a mini-batch size, an initialization function, and the like.

The purpose of learning in an artificial neural network can be seen as determining the model parameters that minimize a loss function. The loss function may be used as an index for determining an optimal model parameter in the learning process of the artificial neural network.

Machine learning can be classified into supervised learning, unsupervised learning, and reinforcement learning according to a learning method.

The supervised learning may refer to a method of training an artificial neural network in a state where a label for learning data is given, and the label may refer to a correct answer (or result value) that the artificial neural network must infer when learning data is input to the artificial neural network. The unsupervised learning may refer to a method of training an artificial neural network in a state where no label is given for learning data. The reinforcement learning may refer to a learning method of training an agent defined in a certain environment to select a behavior or a behavior sequence that maximizes cumulative compensation in each state.

Machine learning, which is implemented as a deep neural network (DNN) including a plurality of hidden layers among artificial neural networks, is also referred to as deep learning, and the deep learning is part of machine learning. Hereinafter, machine learning is used in a sense including deep learning.

The delivery robot 100 may be implemented in a form to which such artificial intelligence and/or machine learning technology is not applied, but in the following, a form in which the artificial intelligence and/or machine learning technology is applied to the delivery robot will be mainly described.

The driving region in which the delivery robot 100 operates may be indoors or outdoors. The delivery robot 100 may operate in a zone partitioned by walls or pillars. In this case, the operation zone of the delivery robot 100 may be set in various ways according to a design purpose, a task attribute of the robot, mobility of the robot, and various other factors. Furthermore, the delivery robot 100 may operate in an open zone that is not predefined. In addition, the delivery robot 100 may sense a surrounding environment to determine an operation zone by itself The operation may be made through artificial intelligence and/or machine learning technology applied to the delivery robot 100.

The delivery robot 100 and the control server 200 may be communicatively connected through the communication network 400 to transmit and receive data to and from each other. Furthermore, the delivery robot 100 and the control server 200 respectively may transmit and receive data to and from the communication device 300 through the communication network 400. Here, the communication network 400 may refer to a communication network that provides a communication environment for communication devices in a wired or wireless manner. For instance, the communication network 400 may be an LTE/5G network. In other words, the delivery robot 100 may transmit and receive data to and from the control server 200 and/or the communication device 300 through an LTE/5G network 500. In this case, the delivery robot 100 and the control server 200 may communicate through a base station connected to the communication network 400 or directly communicate without passing through the base station. In addition, in addition to the LTE/5G network, other mobile communication technology standards or communication methods may be applied to the communication network 400. For instance, the other mobile communication technology standards or communication methods may include at least one of Global System for Mobile communication (GSM), Code Division Multi Access (CDMA), Code Division Multi Access 2000 (CDMA2000), Enhanced Voice-Data Optimized or Enhanced Voice-Data Only (EV-DO), Wideband CDMA (WCDMA), High Speed Downlink Packet Access (HSDPA), High Speed Uplink Packet Access (HSUPA), Long Term Evolution (LTE), Long Term Evolution-Advanced (LTE-A), and the like.

The communication network 400 may include a connection of network elements such as hubs, bridges, routers, switches and gateways. The communication network 400 may include one or more connected networks, for instance, a multi-network environment, including a public network such as the Internet and a private network such as a secure enterprise private network. Access to the communication network 400 may be provided through one or more wired or wireless access networks. Furthermore, the communication network 400 may support various types of M2M communications (Internet of Things (IoT), Internet of Everything (IoE) and Internet of Small Things (IoST) that exchanges and processes information between distributed components such as things.

The delivery robot 100 may perform an operation in the driving region, and may provide information or data related to the operation to the control server 200 through the communication network 400. For instance, the delivery robot 100 may provide the location of the delivery robot 100 and information on the operation being performed to the control server 200. In addition, the delivery robot 100 may receive information or data related to the operation from the control server 200 through the communication network 400. For instance, the control server 200 may provide information on the driving motion control of the delivery robot 100 to the delivery robot 100.

The delivery robot 100 may provide its own status information or data to the control server 200 through the communication network 400. Here, the status information may include information on the location, battery level, durability of parts, replacement cycle of consumables, and the like of the delivery robot 100. Accordingly, the control server 200 may control the delivery robot 100 based on the information provided from the delivery robot 100.

Meanwhile, the delivery robot 100 may provide one or more communication services through the communication network 400, and may also provide one or more communication platforms through the communication services. For instance, the delivery robot 100 communicates with a communication target using at least one service of enhanced mobile broadband (eMBB), ultra-reliable and low latency communications (URLLC), and massive machine-type communications (mMTC).

The enhanced mobile broadband (eMBB) is a mobile broadband service, through which multimedia content, wireless data access, and the like may be provided. In addition, more advanced mobile services such as a hot spot and wideband coverage for receiving explosively increasing mobile traffic may be provided through the eMBB. Large traffic may be received in an area with low mobility and high density of users through a hot spot. A wide and stable wireless environment and user mobility may be secured through wideband coverage.

The ultra-reliable and low latency communications (URLLC) service defines much more stringent requirements than the existing LTE in terms of data transmission/reception reliability and transmission delay, and includes 5G services for production process automation at industrial sites, telemedicine, telesurgery, transportation, safety, and the like.

The massive machine-type communications (mMTC) is a service that is not sensitive to transmission delay requiring a relatively small amount of data transmission. A much larger number of terminals general mobile phones, such as sensors may simultaneously access a wireless access network by the mMTC. In this case, the communication module of the terminal should be inexpensive, and improved power efficiency and power saving technology are required to allow operation for several years without battery replacement or recharging.

The communication service may further include all services that can be provided to the communication network 400 in addition to the eMBB, the URLLC, and the mMTC described above.

The control server 200 may be a server device that centrally controls the delivery system 10000. The control server 200 may control the driving and operation of the delivery robot 100 in the delivery system 10000. The control server 200 may be provided in the driving region to communicate with the delivery robot 100 through the communication network 400. For instance, the control server 200 may be provided in any one of buildings corresponding to the driving region. The control server 200 may also be provided in a place different from the driving region to control the operation of the delivery system 10000. The control server 200 may be implemented as a single server, but may also be implemented as a plurality of server sets, cloud servers, or a combination thereof.

The control server 200 may perform various analyses based on information or data provided from the delivery robot 100, and may control an overall operation of the delivery robot 100 based on the analysis result. The control server 200 may directly control the driving of the delivery robot 100 based on the analysis result. Furthermore, the control server 200 may derive useful information or data from the analysis result and output the derived information or data. Furthermore, the control server 200 may adjust parameters related to the operation of the delivery system 10000 using the derived information or data.

At least one of the delivery robot 100 and the control server 200 communicatively connected through the communication network 400 may be communicably connected to the communication device 300 through the communication network 400. In other words, the delivery robot 100 and the control server 200 may communicate with a device that can be communicably connected to the communication network 400 among the communication devices 300 through the communication network 400. At least one of the delivery robot 100 and the control server 200 may also communicably connected to the communication device 300 through a communication method other than the communication network 400. In other words, at least one of the delivery robot 100 and the control server 200 may communicably connected to a device that can be communicably connected in a manner different from that of the communication network 400 among the communication devices 300. For example, at least one of the delivery robot 100 and the control server 200 may be communicably connected to the communication device 300 using at least one method of Wireless LAN (WLAN), Wireless Personal Area Network (WPAN), Wireless-Fidelity (Wi-Fi), Wireless Fidelity (Wi-Fi) Direct, Digital Living Network Alliance (DLNA), Wireless Broadband (WiBro), World Interoperability for Microwave Access (WiMAX), Zigbee, Z-wave, Blue-Tooth, Radio Frequency Identification (RFID), Infrared Data Association (IrDA), Ultrawide-Band (UWB), Wireless Universal Serial Bus (USB), Near Field Communication (NFC), Visible Light Communication, Light Fidelity (Li-Fi), and satellite communication. In addition, communication may be connected in a communication method other than the above communication methods.

The communication device 300 may refer to any device and/or server capable of communicating with at least one of the delivery robot 100 and the control server 200 through various communication methods including the communication network 400. For instance, the communication device 300 may include at least one of a mobile terminal 310, an information providing system 320, and an electronic device 330.

The mobile terminal 310 may be a communication terminal capable of communicating with the delivery robot 100 and the control server 200 through the communication network 400. The mobile terminal 310 may include a mobile device such as a mobile phone, a smart phone, a wearable device, for example, a watch type terminal (smartwatch), a glass type terminal (smart glass), a head mounted display (HMD), a laptop computer, a digital broadcasting terminal, a personal digital assistant (PDA), a portable multimedia player (PMP), a navigation device, a slate PC, a tablet PC, an ultrabook, and the like.

The information providing system 320 may refer to a system that stores and provides at least one of information reflected in the driving region or related to the driving region, and information related to the operation of the delivery system 10000. The information providing system 320 may be a system (server) that is operable in connection with the delivery robot 100 and the control server 200 to provide data and services to the delivery robot 100 and the control server 200. The information providing system 320 may include at least one of all systems (servers) capable of being communicably connected to and exchanging information with the delivery robot 100 and the control server 200. For instance, at least one of a database system, a service system, and a central control system may be included in the information providing system 320. A specific example of the information providing system 320 may include at least one of a service system of a manufacturer of the delivery robot 100, a service system of a manufacturer of the control server 200, a central (management) control system of a building corresponding to the driving region, a service system of a supplier that supplies energy to a building corresponding to the driving region, an information system of a construction company of a building corresponding to the driving region, a service system of a manufacturer of the mobile terminal 200, a service system of a communication company that provides a communication service through the communication network 400, and a service system of a developer of an application applied to the delivery system 10000. In addition, the information providing system 320 may further include all systems operable in connection with the delivery system 10000 in addition to the above systems.

The information providing system 320 provides various services/information to electronic devices including the delivery robot 100, the control server 200, the mobile terminal 310, and the electronic device 330. The information providing system 320 may be implemented in a cloud to include a plurality of servers, and may perform calculations related to artificial intelligence that are difficult or time-consuming for the delivery robot 100, the mobile terminal 310, and the like to generate a model related to artificial intelligence, and provided related information to the delivery robot 100, the mobile terminal 310, and the like.

The electronic device 330 may be a communication device capable of communicating with at least one of the delivery robot 100 and the control server 200 through various communication methods including the communication network 400 in the driving region. For instance, the electronic device 330 may be at least one of a personal computer, a home appliance, a wall pad, a control device that controls facilities/equipment such as an air conditioner, an elevator, an escalator, and lighting, a watt-hour meter, an energy control device, an autonomous vehicle, and a home robot. The electronic device 330 may be connected to at least one of the delivery robot 100, the control server 200, the mobile terminal 310, and the information providing system 320 in a wired or wireless manner.

The communication device 300 may share the role of the control server 200. For instance, the communication device 300 may acquire information or data from the delivery robot 100 to provide the acquired information or data to the control server 200, or acquire information or data from the control server 200 to provide the acquired information or data to the delivery robot 100. In addition, the communication device 300 may be in charge of at least part of an analysis to be performed by the control server 200, and may provide the analysis result to the control server 200. Furthermore, the communication device 300 may receive the analysis result, information or data from the control server 200 to simply output it. In addition, the communication device 300 may replace the role of the control server 200.

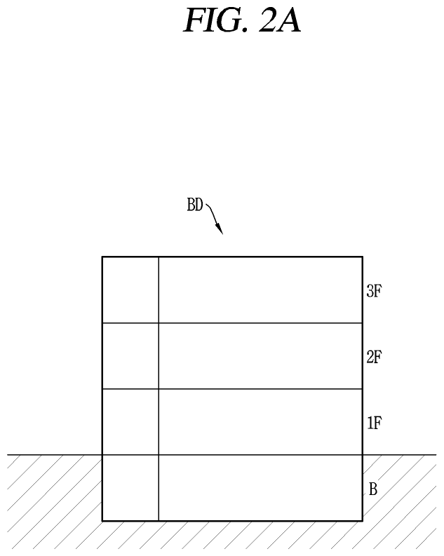

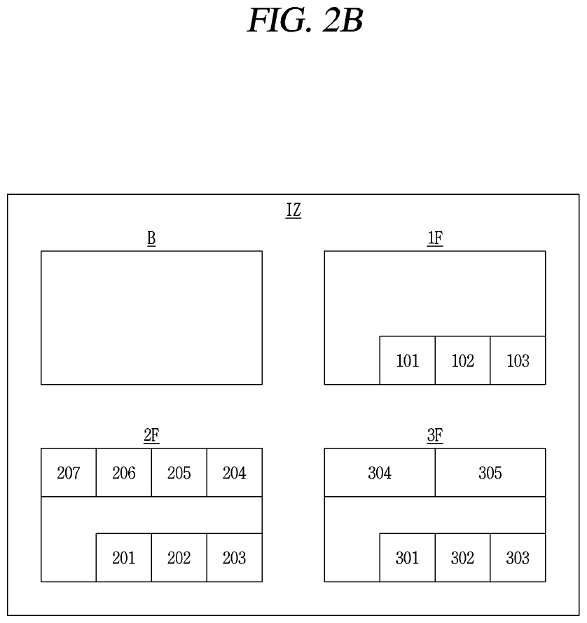

In the delivery system 10000 as described above, the delivery robot 100 may drive in the driving region as shown in FIGS. 2A to 4.

The driving region may include at least a portion of an indoor zone IZ in a building BD with one or more floors, as shown in FIGS. 2A and 2B. In other words, the delivery robot 100 may drive in at least a portion of the indoor zone IZ in a building with one or more floors. For instance, first and second floors in a building consisting of a basement and first to third floors may be included in the driving region, thereby allowing the delivery robot 100 to drive on each of the first and second floors of the building.

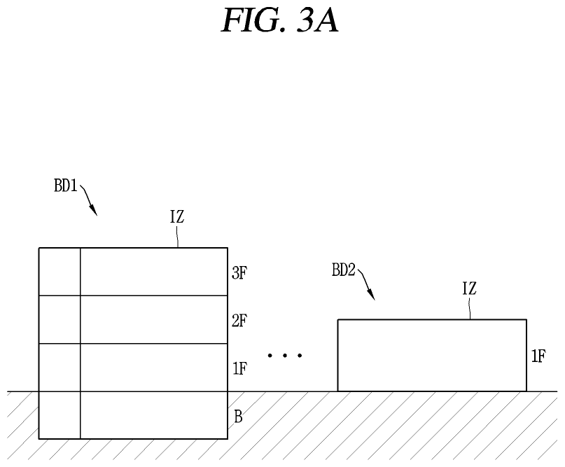

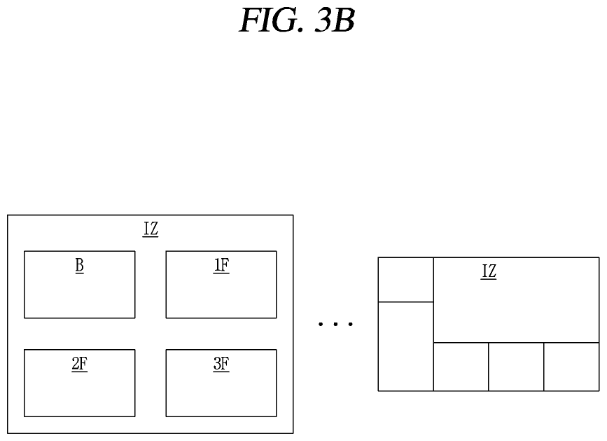

In addition, the driving region may further include at least a portion of the indoor zone IZ in each of a plurality of buildings BD1 and BD2, as shown in FIGS. 3A and 3B. In other words, the delivery robot 100 may drive in at least a portion of the indoor zone IZ in each of the plurality of buildings BD1 and BD2 with one or more floors. For instance, each floor in a first building consisting of a basement, and one to three floors, and a second building consisting of a single story may be included in the driving region, thereby allowing the delivery robot 100 to drive on each of the basement, first to third floors in the first building, and the first floor of the second building.

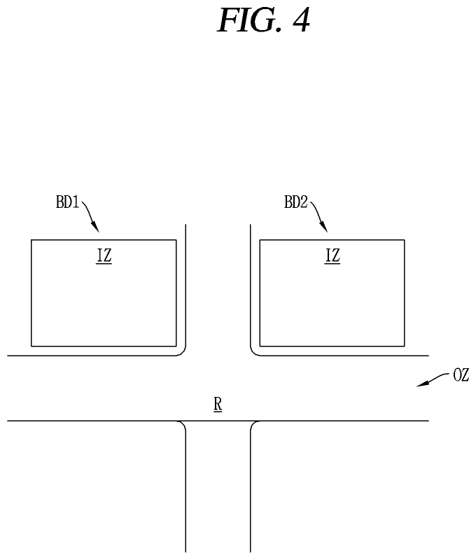

In addition, the driving region may further include an outdoor zone OZ in one or more buildings BD1 and BD2, as shown in FIG. 4. In other words, the delivery robot 100 may drive in the outdoor zone OZ in the one or more buildings BD1 and BD2. For instance, a travel road R around one or more buildings and leading to the one or more buildings may be further included in the driving region, thereby allowing the delivery robot 100 to drive the travel road (R) around one or more buildings and leading to the one or more buildings.

The delivery system 10000 may be a system in which a delivery service is provided through the delivery robot 100 in the driving region. In the delivery system 10000, the delivery robot 100 may perform a specific operation while autonomously driving in the driving region including indoor and outdoor zones, and for instance, the delivery robot 100 may transport products while moving from one point to a specific point in the driving region. In other words, the delivery robot 100 may perform a delivery operation of delivering the products from the one point to the specific point. Accordingly, a delivery service through the delivery robot 100 may be performed in the driving region.

Hereinafter, a detailed configuration of the delivery robot 100 will be described.

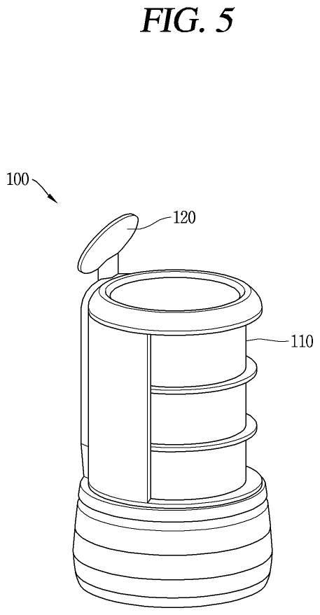

As shown in FIG. 5, the delivery robot 100 may include one or more loading units 110 in a main body. The loading unit 110 may be formed of one or more divided loading spaces in which products can be loaded. In other words, the loading unit 110 may include a plurality of loading spaces to allow one or more products to be loaded separately. In this case, the loading space may be defined in various shapes to allow various groups of products having different sizes to be loaded. The loading space may be an enclosed or closed space, or at least a partially open space. In other words, the loading space may include a space divided only by a partition or the like. A product loaded in the loading unit 110 may be one product or a set of products delivered to a specific customer. The shape and/or structure of the loading unit 110 may be defined in various shapes in the main body. For instance, the loading unit 110 may be implemented in the form of a drawer that is movable in a horizontal direction in the main body.

The loading unit 110 may include a cradle on which a product can be mounted. The cradle may be implemented as a bottom surface of the loading unit 110, or may be implemented as an additional structure attached to the bottom surface of the loading unit 110. In this case, the cradle may be configured to be tiltable, and the delivery robot 100 may further include a configuration for tilting the cradle.

An external configuration of the delivery robot 100 as shown in FIG. 5 is merely an illustration for describing an example of the delivery robot 100, and the external configuration of the delivery robot 100 may be configured in a structure/form other than the illustration shown in FIG. 5, and may further include a configuration different from the foregoing configuration.

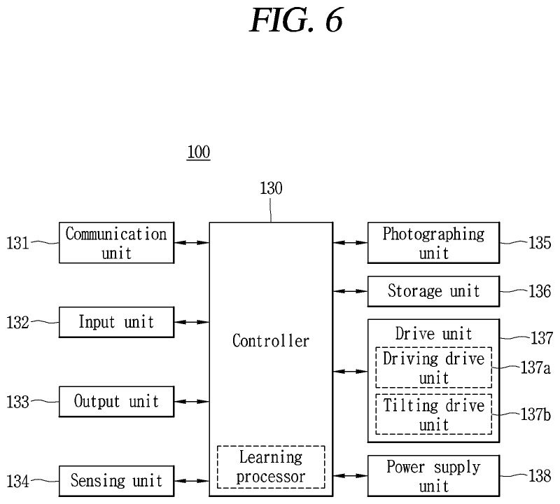

On the other hand, as illustrated in FIG. 6, the delivery robot 100 may include a communication unit 131, an input unit 132, an output unit 133, a sensing unit 134, a photographing unit 135, and a storage unit 136, a drive unit 137, a power supply unit 138, and a controller 130. Here, the elements illustrated in FIG. 6 are not essentially required, and the delivery robot 100 may be implemented by more or fewer elements than the illustrated elements.

The communication unit 131 may include one or more wired/wireless communication modules to transmit and receive information or data to and from communication target devices such as the control server 200 and the communication device 300. The communication unit 131 may transmit and receive sensor information, a user input, a learning model, a control signal, and the like to and from the communication target devices. The communication unit 131 may further include a GPS module that receives a GPS signal from a GPS satellite. In addition, the communication unit 131 may further include a signal reception module capable of receiving a signal transmitted from a signal transmission module provided in the driving region, for instance, at least one of a reception module that receives an ultrasonic signal, a reception module that receives an Ultra-Wide Band (UWB) signal, and a reception module that receives an infrared signal.

The communication unit 131 may receive map information of the driving region from the control server 200 and the communication device 300. The map information may be map information on indoor and outdoor zones in the driving region. The map information may include information on at least one of a location of an indoor zone, a structure, an arrangement, a location of an outdoor zone, a road, a road surface condition, and an inclination angle. The communication unit 131 may provide the received map information to the controller 130. The map information may be used for the determination of a delivery path and/or the driving of the delivery robot 100. The map information may be stored in the storage unit 136.

On the other hand, there may be no limit to a range of area in which the delivery robot 100 is able to deliver a product. However, a delivery range of the delivery robot 100 may be limited to a predetermined region according to a capacity of a battery (power supply unit) of the delivery robot 100, an efficiency of a delivery service, and the like. In this case, the map information may include map information on an entire area that covers the delivery range of the delivery robot 100. In addition, the map information may include only map information on a nearby area that falls within a predetermined range based on a current location of the delivery robot 100.

The communication unit 131 may receive the map information at predetermined intervals. Furthermore, the communication unit 131 may receive the map information when there is a request from the controller 130.

The communication unit 131 may receive product information from the control server 200 or the communication device 300. The product information, including identification information of the product, may include information on at least one of a type, a size, a weight, a shipping address and a destination address, and a delivery date of the product. The communication unit 131 may provide the received product information to the controller 130. The product information may be stored in the storage unit 136.

The communication unit 131 may transmit information on an operation state to the controller 130, and receive a control command for an operation from the controller 130. The communication unit 131 may operate according to the control command received from the controller 130. In other words, the communication unit 131 may be controlled by the controller 130.

The input unit 132 may include at least one of input elements such as at least one button, a switch, a touchpad, a microphone for acquiring an audio signal, and the like, and an output element such as a display to receive various types of data including user commands, and output the operating state of the delivery robot 100. For example, a command for the execution of a delivery service may be input through the display, and a state for the execution of the delivery service may be output. Here, the display may be configured with any one of a light emitting diode (LED), a liquid crystal display (LCD), a plasma display panel, and an organic light emitting diode (OLED). The elements of the input unit 132 may be disposed in various locations in consideration of the convenience of a shipper or a recipient. For example, as illustrated in FIG. 5, the input unit 132 may be disposed on a head unit 120 of the delivery robot 100.

The input unit 132 may display an operation state of the delivery robot 100 through the display, and display a control screen on which a control operation of the delivery robot 100 is carried out. The control screen may refer to a user interface screen on which a driving state of the delivery robot 100 is displayed, and to which a command for a driving operation of the delivery robot 100 is input from a user. The control screen may be displayed on the display through the control of the controller 130, and the display on the control screen, the input command, and the like may be controlled by the controller 130.

The input unit 132 may receive the product information from the shipper. Here, the product information may be used as learning data for training an artificial neural network. In this case, the artificial neural network may be trained to output a type of a product corresponding to the image, voice, and text indicating the product. The input unit 132 may provide the received product information to the controller 130.

The input unit 132 may also acquire input data to be used when acquiring an output using learning data and a learning model for training the artificial neural network. The input unit 132 may acquire unprocessed input data, and in this case, the controller 130 may extract an input feature point by preprocessing the input data.

The input unit 132 may transmit information on an operation state to the controller 130, and receive a control command for an operation from the controller 130. The input unit 132 may operate according to a control command received from the controller 130. In other words, the input unit 132 may be controlled by the controller 130.

The output unit 133 may generate an output related to visual, auditory or tactile sense. The output unit 133 may include a display that outputs visual information, a speaker that outputs auditory information, and a haptic module that outputs tactile information. At least some elements of the output unit 133 may be disposed on the head unit 120 of the delivery robot 200 together with the input unit 132.

When an event occurs during the operation of the delivery robot 100, the output unit 133 may output an alarm related to the event. For example, when the operating power of the delivery robot 100 is exhausted, a shock is applied to the delivery robot 100, or an accident occurs in the driving region, an alarm voice may be output to transmit information on the accident to the surroundings.

The output unit 133 may transmit information on an operation state to the controller 130, and receive a control command for an operation from the controller 130. The output unit 133 may operate according to a control command received from the controller 130. In other words, the output unit 133 may be controlled by the controller 133.

The sensing unit 134 may include one or more sensors that sense information on the posture and operation of the delivery robot 100. For instance, the sensing unit 134 may include at least one of a tilt sensor that senses a movement of the delivery robot 100 and a speed sensor that senses a driving speed of the drive unit 11. When the delivery robot 100 is inclined in a front, rear, left, or right direction, the tilt sensor may calculate an inclined direction and angle thereof to sense the posture information of the delivery robot 100. A tilt sensor, an acceleration sensor, or the like may be used for the tilt sensor, and any of a gyro type, an inertial type, and a silicon semiconductor type may be applied in the case of the acceleration sensor. Moreover, in addition, various sensors or devices capable of sensing the movement of the delivery robot 100 may be used. The speed sensor may be a sensor that senses a driving speed of a driving wheel provided in the delivery robot 100. When the driving wheel rotates, the speed sensor may sense the rotation of the driving wheel to detect the driving speed.

The sensing unit 134 may further include various sensors for sensing internal information, surrounding environment information, user information, and the like of the delivery robot 100. For instance, a proximity sensor, an RGB sensor, an IR sensor, an illuminance sensor, a humidity sensor, a fingerprint recognition sensor, an ultrasonic sensor, an optical sensor, a 3D sensor, a microphone, a lidar, a radar, a cliff detection sensor, and any combinations thereof capable of detecting an obstacle in the driving region while the delivery robot 100 is driving in the driving region may be further included in the sensing unit 134. Here, the cliff detection sensor may be a sensor in which one or more of an infrared sensor having a light emitting unit and a light receiving unit, an ultrasonic sensor, an RF sensor, and a Position Sensitive Detector (PSD) sensor are combined. The PSD sensor is a type of infrared sensor that uses infrared rays to transmit infrared rays and then measure an angle of infrared rays reflected from and returned back to an obstacle to measure a distance. In other words, the PSD sensor may calculate a distance from the obstacle using a triangulation method. Sensor data acquired by the sensing unit 134 may be a basis for allowing the delivery robot 100 to autonomously drive.

The sensing unit 134 may transmit information on a sensing result to the controller 130 and receive a control command for an operation from the controller 130. The sensing unit 134 may operate according to a control command received from the controller 130. In other words, the sensing unit 134 may be controlled by the controller 130.

The photographing unit 135 may include one or more cameras (sensors) that photograph the surroundings of the delivery robot 100. The photographing unit 135 may generate image information on the driving region by photographing the surroundings while the delivery robot 100 is driving in the driving region. The photographing unit 135 may photograph the front of the delivery robot 100 to sense an obstacle present in the vicinity of the delivery robot 100 and in the driving region. The photographing unit 135 as a digital camera may include an image sensor. The image sensor, which is a device that converts an optical image into an electrical signal, is composed of a chip in which a plurality of photo diodes are integrated, and a pixel is exemplified as a photo diode. Charges are accumulated in each of the pixels by an image formed on the chip by light passing through a lens, and the charges accumulated in the pixels are converted into an electrical signal (e.g., voltage). For the image sensor, CCD (Charge Coupled Device), CMOS (Complementary Metal Oxide Semiconductor), or the like are well known. In addition, the photographing unit 135 may include the image processing unit DSP that generates the image information through image processing on the photographed result.

The photographing unit 135 including the image sensor and the image processing unit may include at least one of a 2D camera sensor and a 3D camera sensor. Here, the three-dimensional camera sensor may be attached to one side or a part of the deliver robot 100 to generate three-dimensional coordinate information related to the surroundings of the main body of the delivery robot 100. In other words, the three-dimensional camera sensor may be a three-dimensional (3D) depth camera that calculates a near and far distance of the delivery robot 100 and an object to be photographed. Specifically, the three-dimensional camera sensor may photograph a two-dimensional image related to the surroundings of the delivery robot 100, and generate a plurality of three-dimensional coordinate information corresponding to the photographed two-dimensional image.

The three-dimensional camera sensor may include two or more cameras that acquire a conventional two-dimensional image, and may be formed in a stereo vision manner to combine two or more images obtained from the two or more cameras to generate three-dimensional coordinate information. Specifically, the three-dimensional camera sensor may include a first pattern irradiation unit for irradiating light with a first pattern in a downward direction toward the front of the main body of the delivery robot 100, and a second pattern irradiation unit for irradiating the light with a second pattern in an upward direction toward the front of the main body, and an image acquisition unit for acquiring an image in front of the main body. As a result, the image acquisition unit may acquire an image of an area where light of the first pattern and light of the second pattern are incident. The three-dimensional camera sensor may include an infrared ray pattern emission unit for irradiating an infrared ray pattern together with a single camera to photograph the shape of the infrared ray pattern irradiated from the infrared ray pattern emission unit onto the object to be photographed, thereby measuring a distance between the sensor and the object to be photographed. Such a three-dimensional camera sensor may be an infrared (IR) type three-dimensional camera sensor. In addition, the three-dimensional camera sensor may include a light emitting unit that emits light together with a single camera to receive part of laser emitted from the light emitting unit and reflected from the object to be photographed, and analyze the received laser, thereby measuring a distance between the three-dimensional camera sensor and the object to be photographed. Such a three-dimensional camera sensor may be a time-of-flight (TOF) type three-dimensional camera sensor. Specifically, the laser of the above-described three-dimensional camera sensor is configured to irradiate a laser beam in the form of extending in at least one direction. In one example, the three-dimensional camera sensor may include first and second lasers, in which the first laser irradiates a linear shaped laser intersecting each other, and the second laser irradiates a single linear shaped laser. According to this, the lowermost laser is used to sense obstacles in the bottom portion, the uppermost laser is used to sense obstacles in the upper portion, and the intermediate laser between the lowermost laser and the uppermost laser is used to sense obstacles in the middle portion.

Meanwhile, the photographing unit 135 may acquire an image by photographing the vicinity of the delivery robot 100 while the delivery robot 100 drives in the driving region, and the controller 130 may recognize a current location of the delivery robot 100 based on the photographed and acquired image by the photographing unit 135. Hereinafter, an image acquired by the photographing unit 135 is defined as an “acquired image”. The acquired image may include various features such as lights located on the ceiling, edges, corners, blobs, and ridges. The controller 130 detects a feature from each of the acquired images, and calculates a descriptor based on each feature point. Here, the descriptor denotes data in a predetermined format for representing a feature point, and denotes mathematical data in a format capable of calculating a distance or a degree of similarity between the descriptors. For example, the descriptor may be an n-dimensional vector (n is a natural number) or data in a matrix format. The controller 130 classifies at least one descriptor for each acquired image into a plurality of groups according to a predetermined sub-classification rule based on descriptor information obtained through the acquired image at each location, and converts descriptors included in the same group according to a predetermined sub-representative rule into sub-representative descriptors, respectively. For another example, all descriptors collected from acquired images within a predetermined zone such as a room are classified into a plurality of groups according to a predetermined sub-classification rule, and descriptors included in the same group according to the predetermined sub-representative rule are respectively classified as sub-representative descriptors. The controller 130 may obtain the feature distribution of each location through this process. Each location feature distribution may be expressed as a histogram or an n-dimensional vector. For another example, the controller 130 may estimate an unknown current location based on descriptors calculated from each feature point without going through a predetermined sub-classification rule and a predetermined sub-representative rule. Furthermore, when the current location of the delivery robot 100 becomes unknown due to a location jump or the like, the current location may be estimated based on data such as a pre-stored descriptor or a sub-representative descriptor.

The photographing unit 135 may generate an acquired image by photographing an image at an unknown current location. The controller 130 detects various features such as lights located on the ceiling, edges, corners, blobs, and ridges through the acquired image to calculate a descriptor. The controller 130 may convert the acquired image into information (sub-recognition feature distribution) that is comparable with location information to be compared (e.g., feature distribution of each location) according to a predetermined sub-conversion rule based on at least one descriptor information obtained through the acquired image of the unknown current location. According to a predetermined sub-comparison rule, each location feature distribution may be compared with each recognition feature distribution to calculate each degree of similarity. A degree of similarity (probability) may be calculated for the location corresponding to each location, and a location from which the greatest probability is calculated may be determined as a current location. Accordingly, the controller 130 may divide a zone in the driving region, and generate a map consisting of a plurality of areas, or recognize the current location of the delivery robot 100 based on a pre-stored map.

The photographing unit 135 may transmit a photographing result including the acquired image to the controller 130, and may receive a control command for an operation from the controller 130. The photographing unit 135 may operate according to a control command received from the controller 130. In other words, the photographing unit 135 may be controlled by the controller 130.

The storage unit 136 may be a storage element that stores data that can be read by a microprocessor. The storage unit 136 may include at least one of a hard disk drive (HDD), a solid state disk (SSD), a silicon disk drive (SDD), a ROM, a RAM, a CD-ROM, a magnetic tape, a floppy disk, and an optical data storage device. The storage unit 136 may store data supporting various functions of the delivery robot 100. The storage unit 136 may store data calculated/processed by the controller 130. The storage unit 136 may also store information or data received by the communication unit 131, input information acquired by the input unit 132, input data, learning data, a learning model, a learning history, and the like. For instance, at least one of the product information and the map information received from the communication unit 131 or the input unit 132 may be stored in the storage unit 136. In this case, the map information and the product information may be previously collected from the control server 200 and stored in the storage unit 136, and may be periodically updated. In addition, data related to the driving of the delivery robot 100, for instance, program data such as an operating system, firmware, an application, and software of the delivery robot 100.

The drive unit 137 may be a driving element that drives the physical operation of the delivery robot 100. The drive unit 137 may include a driving drive unit 137a. The driving drive unit 137a, as driving wheels provided under the main body of the delivery robot 100, may be rotationally driven to drive the delivery robot 100 to drivel in the driving region. The driving drive unit 137a may include an actuator or a motor operating according to a control signal of the controller 130 to move the delivery robot 100. The driving drive unit 137a may rotate the driving wheels provided at each left/right side of each front/rear side of the main body in both directions to rotate or move the main body. In this case, the left and right wheels may move independently. Furthermore, the driving drive unit 137a may move the main body forward, backward, leftward, and rightward, or may allow the main body to drive in a curve or rotate in place. The driving drive unit 137a may further include a wheel, a brake, a propeller, and the like operated by an actuator or a motor.

The drive unit 137 may further include a tilting drive unit 137b. The tilting drive unit 137b may tilt the cradle of the loading unit 110 according to a control signal of the controller 130. The tilting drive unit 137b may tilt the cradle using various methods known to those skilled in the art. The tilting drive unit 137b may include an actuator or a motor for operating the cradle.

The drive unit 137 may transmit information on a driving result to the controller 130, and receive a control command for an operation from the controller 130. The drive unit 137 may operate according to a control command received from the controller 130. In other words, the drive unit 137 may be controlled by the controller 130.

The power supply unit 138 may include the battery that can be charged by external commercial power to supply power stored in the battery into the delivery robot 100. Here, the battery may store power collected by sunlight or harvesting in the battery in addition to the external commercial power. The power supply unit 138 supplies driving power to each of the components included in the delivery robot 100 to supply operating power required for the delivery robot 100 to drive or perform a specific function. Here, the controller 130 may sense the remaining power of the battery, and control the battery to move power to a charging unit connected to the external commercial power source when the remaining power is insufficient, and thus a charge current may be supplied from the charging unit to charge the battery.

The battery may be connected to a battery sensing unit to transmit a remaining power level and a charging state to the controller 130. At this time, the output unit 133 may display the remaining amount of the battery by the controller 130.

The controller 130 may perform overall operation control of the delivery robot 100. The controller 130 may be configured in a modular form including one or more processors for processing information to perform learning, inference, perception, calculation, determination and signal processing of information on the operation control of the delivery robot 100 in the processor. The processor may refer to a data processing device embedded in hardware having a physically structured circuit to perform a function written as a code or an command included in a program. An example of the data processing device embedded in hardware as described above may be one of a mobile processor, an application processor (AP), a microprocessor, a central processing unit (CPU), a graphic processing unit (GPU), a neural processing unit (NPU), a processor core, a multiprocessor, an application-specific integrated circuit (ASIC), and a field programmable gate array (FPGA).

The controller 130 may determine at least one executable operation of the delivery robot 100 based on information determined or generated using a data analysis algorithm or a machine learning algorithm. The controller 130 may perform at least one of learning, inference, and processing on a vast amount of information (big data), such as information stored in the delivery robot 100, environmental information around the driving region, and information stored in a communicable external storage. Furthermore, the controller 130 may predict (or infer) at least one executable operation of the robot 100 based on the learned information learned, and determine the most feasible operation among the at least one predicted operation to control the delivery robot 100 to perform the determined operation. In this case, the controller 130 may control at least one of the elements of the delivery robot 100 to perform the determined operation. For instance, according to a target operation of the delivery robot 100, the controller 130 may control the communication unit 131, the input unit 132, the output unit 133, the sensing unit 134, the photographing unit 135, the storage unit 136, the drive unit 137, and the power supply unit 138 to control the target operation to be performed. Furthermore, the controller 130 may further control other elements included in the delivery robot 100 in addition to the above elements.

Meanwhile, the controller 130 may further include a learning processor for performing artificial intelligence and/or machine learning. In this case, the learning processor may be manufactured in a separate configuration from the controller 130 and configured in a modular form embedded in the controller 130, or may be configured as part of the controller 130. In addition, the controller 130 itself may be configured with an artificial intelligence processor mounted with the learning processor. The controller 130 may request, search, receive, or utilize information or data of the learning processor or the storage unit 136, and may control one or more of the elements of the delivery robot 100 to execute a predicted operation or an operation determined to be preferred among at least one executable operation. The controller 130 may control at least part of the elements of the delivery robot 100 in order to drive an application program stored in the storage unit 136. Moreover, in order to drive the application program, the controller 130 may operate two or more of the elements included in the delivery robot 100 in combination with one another. Furthermore, the controller 130 may generate a control signal for controlling the external device when it is necessary to link with an external device such as the control server 200 and the communication device 300 to perform the determined operation, and transmit the generated control signal to the external device.

Meanwhile, the controller 130 may use training data stored in one or more of the control server 200, the communication device 300, and the storage unit 136. In addition, the controller 130 may be mounted with a learning engine that detects a feature for recognizing a predetermined object to recognize the object through the learning engine. Here, the feature for recognizing an object may include a size, a shape, a shade and the like of the object. Specifically, when the controller 130 inputs part of images acquired through the photographing unit 135 to the learning engine, the learning engine may recognize at least one thing or creature included in the input images. Furthermore, the learning engine as described above may be mounted on one or more of external servers included in the control server 200 and the communication device 300. When the learning engine is mounted on at least one of the control server 200 and the external server, the controller 130 may control the communication unit 131 to transmit at least one image that is subjected to analysis to one or more of the control server 200 and the external server. In this case, one or more of the control server 200 and the external server that has received image data may input the image received from the delivery robot 100 to the learning engine, thereby recognizing at least one thing or creature included in the image. Moreover, one or more of the control server 200 and the external server that has received the image data may transmit information related to the recognition result back to the delivery robot 100. At this time, the information related to the recognition result may include information related to a number of objects included in the image that is subjected to analysis, and a name of each object.

The controller 130 may control the driving drive unit 137a to allow the delivery robot 100 to drive in the driving region according to a setting. The controller 130 may control the driving drive unit 137a to control the delivery robot 100 to drive straight or in rotation. The controller 130 may control the driving drive unit 137a based on sensor data received from the sensing unit 134 for autonomous driving in the driving region. The controller 130 may control the driving drive unit 137a in various ways known to those skilled in the art to allow the delivery robot 100 to autonomously drive to a delivery destination.

The controller 130 may set a movement path capable of moving from the driving region to a destination based on information received through the communication unit 131, for instance, information on a location of the delivery robot 100. In other words, the controller 130 may determine and set a movement path capable of moving to a destination based on the current location, and control the delivery robot 100 to drive accordingly. To this end, the controller 130 may receive map information, road information, and necessary information on an area to be moved from one or more of the control server 200 and the communication device 300, and store the received information in the storage unit 136. For example, the controller 130 may drive a navigation application stored in the storage unit 136 to control the driving of the delivery robot 100 to move to a place input by a user. Furthermore, the controller 130 may control driving to avoid an obstacle in the driving region according to information input by at least one of the sensing unit 134 and the photographing unit 135. In this case, the controller 130 may reflect information on the obstacle in information on the driving region pre-stored in the storage unit 136, for instance, the map information.

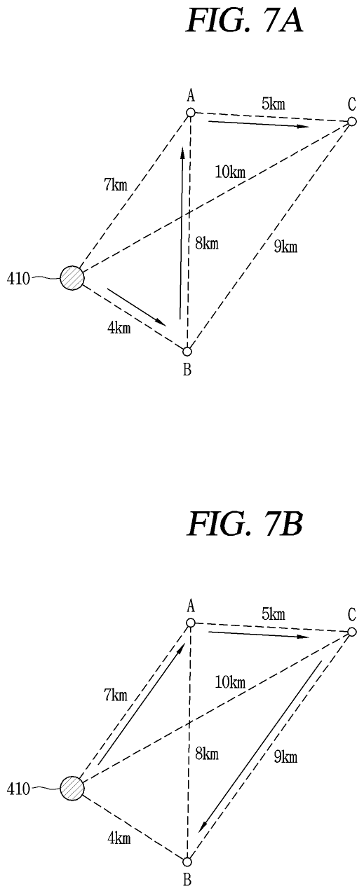

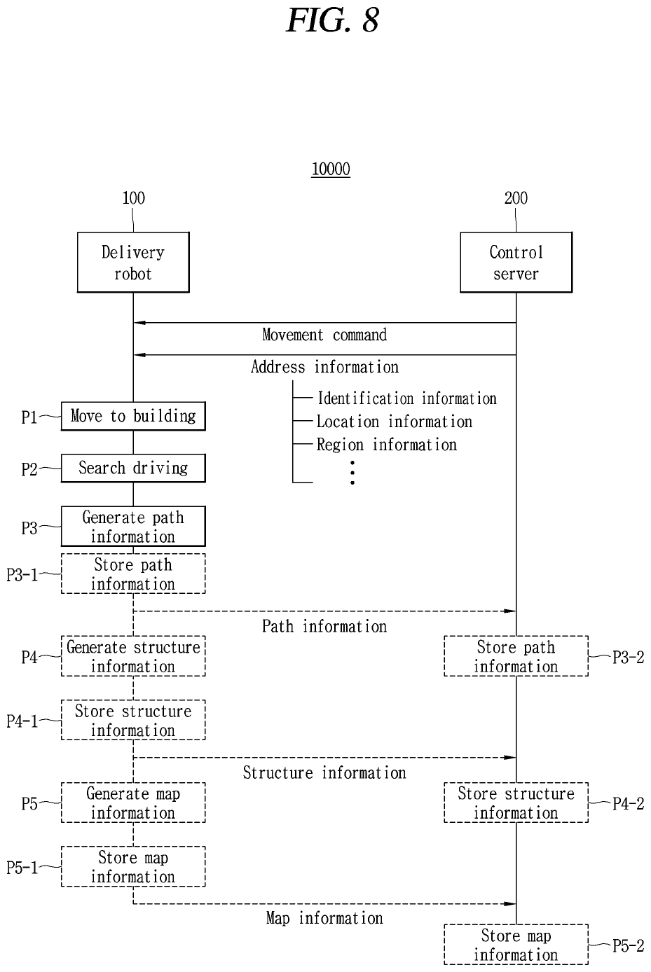

Here, a specific example in which the controller 130 determines and sets a movement path for delivering a product will be described with reference to FIGS. 7A and 7B.

The controller 130 may determine and set a movement path based on the determined or input type of the product. The controller 130 may refer to map information stored in the storage unit 136 to set the movement path. The controller 130 may determine the shortest path to a delivery destination, alternative paths, expected arrival time, and the like using various methods known to those skilled in the art. The controller 130 may determine a delivery sequence of products based on delivery distances or expected delivery times of the products. Here, the delivery distance may denote a distance to a delivery destination, and the expected delivery time may denote an estimated time required to reach the delivery destination. Referring to FIGS. 7A and 7B, the controller 130 may determine delivery distances or expected delivery times with reference to the locations of delivery destinations A, B, and C, and in this case, the delivery robot 100 may determine not only delivery distances or expected delivery times from a current location 410 of the delivery robot 100 to the delivery destinations A, B, and C, respectively, but also delivery distances or expected delivery times between the delivery destinations A, B, and C. The controller 130 may set the movement path based on the determination result, and control the delivery robot 100 to drive to perform delivery accordingly. For an example, the controller 130 may set a delivery sequence in the order of a nearest delivery destination B, a delivery destination A and a delivery destination C (i.e., B-A-C) from the current location 410 to perform deliveries in the minimum time as illustrate in FIG. 7A, or the controller 130 may set the delivery sequence in the order of the delivery destination A, the delivery destination C, and the delivery destination B (A-C-B) to drive in the shortest distance from the current location 410.

Meanwhile, the controller 130 may adjust a movement speed of the delivery robot 100 or a tilted angle of the cradles of the loading unit 110 based on a condition of a road surface or an inclination angle of the road surface in the driving region. Information on the condition or inclination angle of the road surface may be included in the map information. The controller 130 may acquire information on the condition or inclination angle of the road surface in the driving region currently being driven or to be driven by referring to the map information. In addition, the controller 130 may determine the condition or inclination angle of the road surface in the driving region based on data from one or more of the communication unit 131, the input unit 132, the sensing unit 134, and the photographing unit 135. In this case, whether the road surface is in good condition may be determined based on a vibration generated in the delivery robot 100, and the inclination angle of the road surface may be determined from a posture or inclination of the delivery robot 100. In this case, the controller 130 may control the driving drive unit 137a based on at least one of the condition or inclination angle of the surface condition to adjust the movement speed of the delivery robot 100. For example, the controller 130 may decrease the movement speed when a vibration above a predetermined level is generated in the delivery robot 100 or the delivery robot 100 drives on a downhill road. Furthermore, the controller 130 may control the tilting drive unit 137b based on the inclination angle of the road surface to adjust the tilted angle of the cradle. For example, when the delivery robot 100 drives on an uphill or downhill road, the angle may be adjusted in a direction to offset leaning induced by the uphill road or the downhill road.

In addition, the controller 130 may determine a network shadow region located on the movement path based on a pre-learned network performance estimation model based on time and location. Specifically, the controller 130 may estimate a network performance numerical rating according to time at each predetermined point set on the movement path through the network performance estimation model, and determine a network shadow region located on the movement path based on the estimated network performance numerical rating. Specifically, the controller 130 may determine a network shadow region located on the movement path when the estimated network performance numerical rating is below a predetermined rating. Furthermore, the determination of the network shadow region may be performed by at least one of the information providing system 320 included in the control server 200 and the communication device 300 to be provided to the delivery robot 100. The controller 130 may update the movement path to avoid the determined network shadow region, and may control the drive unit 137 to move along the updated movement path.

Here, the network shadow region may refer to a point where it is difficult for a currently used application program to perform a normal operation. For instance, the network shadow region may be a region in which the network performance numerical rating is below a predetermined value, and may be region in which it is difficult to receive or transmit predetermined information or in which data is transmitted at a rate lower than a reference value. For example, the network shadow region may be a region in which a base station is not installed, a hotspot area, an underpass, a tunnel, and the like, but the present disclosure is not limited thereto.

When it is difficult to avoid the network shadow region, the controller 130 may store information necessary to pass through the network shadow region in the storage unit 136 prior to entering the network shadow region. Furthermore, the controller 130 may control the drive unit 137 to directly pass through the network shadow region without performing an attempt to avoid the network shadow region. At this time, the controller 130 may store information necessary for an application program in use or scheduled to be used prior to passing through the network shadow region in the storage unit 136 in advance, and large size information (such as photographed images) to be transmitted may be transmitted to one or more of the control server 200 and the communication device 300 in advance.

The controller 130 may extract region feature information based on the acquired images acquired through the photographing unit 135. Here, the extracted region feature information may include a set of probability values for a region and a thing recognized based on the acquired images. The controller 130 may determine a current location based on SLAM-based current location node information and the extracted region feature information. Here, the SLAM-based current location node information may correspond to a node most similar to the feature information extracted from the acquired image among pre-stored node feature information. In other words, the controller 1800 may perform location recognition using feature information extracted from each node to select the current location node information. In addition, in order to further improve the accuracy of location estimation, the controller 130 may perform location recognition using both feature information and region feature information to increase the accuracy of location recognition. For example, the controller 130 may select a plurality of candidate SLAM nodes by comparing the extracted region feature information with pre-stored region feature information, and determine current location based on candidate SLAM node information most similar to the SLAM-based current location node information among the plurality of the selected candidate SLAM nodes. Alternatively, the controller 130 may determine SLAM-based current location node information, and correct the determined current location node information according to the extracted region feature information to determine a final current location. In this case, the controller 130 may determine a node most similar to the extracted region feature information among pre-stored region feature information of nodes existing within a predetermined range based on the SLAM-based current location node information as the final current location.

For a location estimation method using an image, a global feature describing an overall shape of an object rather than a local feature as well as a location estimation method using a local feature point such as a corner may be used for location estimation, thereby extracting a feature that is robust to an environmental change such as lighting/illuminance. For example, the controller 130 may extract and store region feature information (e.g., building exterior, road, outdoor structure/facility, indoor structure/facility, ceiling, stairs, etc.) during map generation, and then estimate the location of the delivery robot 100 using various region feature information. In other words, according to the present disclosure, it may be possible to store a feature in the unit of thing, object and region instead of using only a specific point in the image when storing the environment, thereby allowing location estimation that is robust to a change in lighting/illuminance.

On the other hand, when the delivery robot 100 enters a blind zone formed by a thing, a field of view of the photographing unit 135 may be blocked, thereby preventing an image having a sufficient feature point such as a corner from being acquired. Alternatively, in an environment with a high ceiling, the accuracy of extracting a feature point using the ceiling image may be lowered at a specific location. However, the controller 130 according to an embodiment may recognize a current location using the region feature information even when an identification accuracy of feature point is low due to a high ceiling.

The delivery robot 100 configured as described above may perform an operation according to a plurality of operation modes. Here, the operation mode refers to a mode in which the delivery robot 100 performs an operation according to a predetermined reference, and one of the plurality of operation modes may be set through one or more of the delivery robot 100, the control server 200, and the communication device 300. For instance, a control screen according to an operation mode set in one or more of the delivery robot 100, the control server 200, and the communication device 300 may be displayed, and the delivery robot 100 may perform an operation according to the operation mode in response to the manipulation of the control screen. In other words, the delivery system 10000 may control the operation of the delivery robot 100 and perform the resultant operation according to any one or more set operation modes among the plurality of operation modes.

Hereinafter, each embodiment of the delivery robot, the delivery system, and the driving method of the delivery robot to be provided in the present disclosure will be described in detail.

The delivery robot 100 as a mobile robot that drives in at least one of an outdoor zone OZ and an indoor zone IZ in the delivery system 10000 as illustrated in FIG. 1 includes the communication unit 131, the sensing unit 134, the photographing unit 135, the drive unit 137, and the controller 130 among the elements of the delivery robot 100 as illustrated in FIG. 6. Here, the communication unit 131 communicates with the control server 200 that controls the delivery robot 100, the sensing unit 134 senses one or more pieces of information related to the state of the delivery robot 100, the photographing unit 135 photographs the surroundings of the delivery robot 100, the drive unit 137 moves the main body of the delivery robot 100, and the controller 130 controls one or more of the communication unit 131, the sensing unit 134, the photographing unit 135, and the drive unit 137 to control the operation of the delivery robot 100. For instance, when the control server 200 transmits an operation command to the communication unit 131, the communication unit 131 may receive the operation command to transmit the received operation command to the controller 130, the controller 130 may control the drive unit 137 to allow the delivery robot 100 to move to a destination according to the operation command, and control the communication of the communication unit 131, the sensing of the sensing unit 134, and the photographing of the photographing unit 135 during driving while moving to the destination, and also control the operation of the delivery robot 100 based on a communication result of the communication unit 131, a sensing result of the sensing unit 134, and a photographing result of the photographing unit 135 to control the delivery robot 100 to perform a specified command. The delivery robot 100 may also further include one or more of the input unit 132, the output unit 133, the storage unit 136, and the power supply unit 138, as illustrated in FIG. 6. Preferably, all of the elements shown in FIG. 6 may be included therein, but hereinafter, the minimum required configuration for describing the embodiment of the delivery robot 100 will be mainly described.

The delivery robot 100 is an artificial intelligence mobile robot capable of autonomously driving in a driving region including one or more of the outdoor zone OZ and the indoor zone IZ. Specifically, the delivery robot 100 may photograph an image around the delivery robot 100 through the photographing unit 135 while driving, and the controller 130 may analyze a photographing result of the photographing unit 135 to control driving while recognizing information in the driving path. Accordingly, in the delivery system 10000, the delivery robot 100 may implement VISION AI that analyzes and drives image information photographed based on artificial intelligence. In other words, the delivery robot 100 may be a robot that operates based on VISION AI and drives in the driving region.

In addition, the delivery robot 100 may operate based on VISION AI, and transmit and receive data while communicating in real time with the control server 200 and one or more communication targets. For instance, when the controller 130 determines to transmit the driving information of the delivery robot 100 to the control server 200 while driving, the driving information may be controlled to be transmitted in real time to the control server 200 through the communication unit 131. In addition, data received from the control server 200 through the communication unit 131 may be processed in real time. Accordingly, data transmission and reception may be performed in real time, and data calculation and processing may also be performed in real time.

In the delivery system 10000, when the delivery robot 100 moves to a destination in which path information or map information does not exist, the delivery robot 100 may perform initial driving in a region corresponding to the destination. Specifically, the delivery robot 100 may perform initial search driving in a region corresponding to the destination, and generate path information on the destination based on a result of the search driving, and drive using the generated path information when driving to the destination later.

In the delivery robot 100 for performing the initial search driving as described above, the controller 130 receives address information of an address location from the control server 200 when moving to the address location where path information is not generated among address locations in the indoor zone IZ. In this regard, the address information of the address location is not limited to information received from the control server 200, and also received from another terminal or another server operating in connection with the delivery robot 100 or still another terminal connected to the other server depending on the application. Another terminal operating in connection with the delivery robot 100 may be a terminal located at a place providing a delivery service. Another server operating in connection with the delivery robot 100 may be any other server other than the control server 200, and another terminal connected to the other server may be a terminal located at a place where a delivery service is to be provided.

The controller 130 controls driving while searching for the address location in a building corresponding to the address location based on the address information, and generates path information to the address location based on the address information, a driving path while searching for the address location, and a sensing result of the sensing unit 134a, and a photographing result of the photographing unit 135. In other words, the delivery robot 100 may receive a move command to the address location from the control server 200, and then receive the address information from the control server 200 to drive while searching for the address location based on the address information, and generate the path information based on the address information and the driving result to perform initial search driving for the address location.

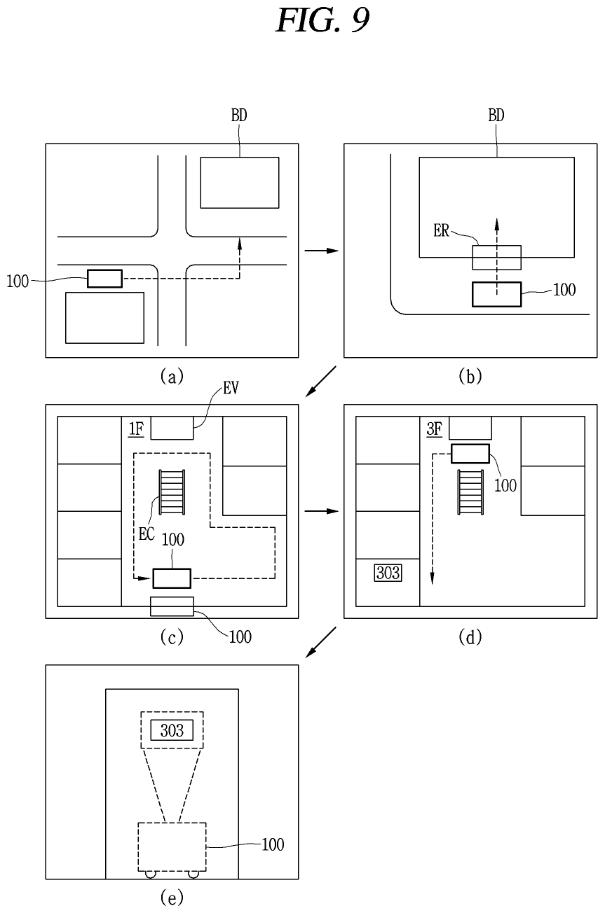

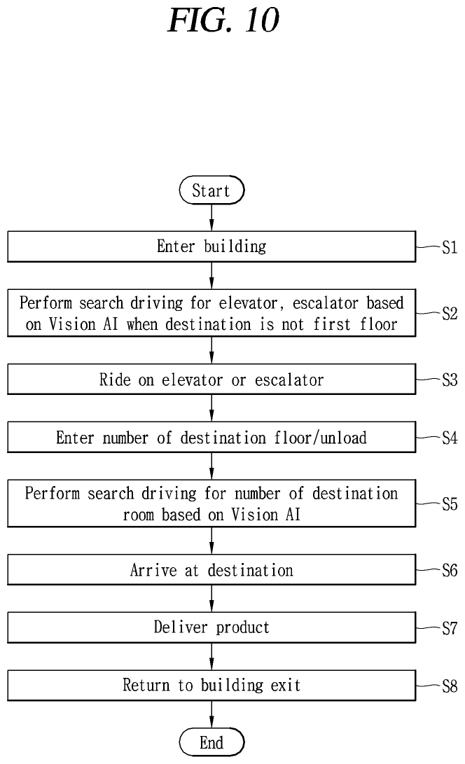

Here, the address information may include identification information on the address location, location information on a building corresponding to the address location, and region information on an region of the building. The identification information may be information on a building/floor/number of the address location. For instance, the identification number may be represented as “No. Z, Y-th floor, Building X”. The identification information may also be information capable of recognizing an identification device attached to the address location. For instance, the identification information may be a model number of the identification device attached to the address location. The location information may be coordinate information where the building is located. For instance, for GPS coordinate information of the building, the location information may be expressed as (x, y, z). The region information may be coordinate information indicating an area of the building. For instance, the GPS coordinate information of the building may be represented by (x, y, z) or (a, b, c). The controller 130 may perform search driving at the address location based on the identification information, the location information, and the region information included in the address information as described above. An operation sequence of the delivery robot 100 performing an initial driving to the address location based on the address information may be as illustrated in FIGS. 8 and 9.

When moving from a location other than the building to the address location, the controller 130 may control the delivery robot 100 to move to the building based on the location information. Accordingly, the delivery robot 100 may move to the building BD (P1) to start search driving for the address location. In other words, when starting moving from the outdoor zone OZ to the address location as illustrated in (a) of FIG. 9, the delivery robot 100 may move to the building BD (P1) based on the location information (P1).

When moving from an outside of the building to an inside of the building, the controller 130 may control the delivery robot 100 to enter an entrance of the building while moving below a preset reference speed. Accordingly, the delivery robot 100 may enter the building while moving through the entrance below the reference speed. In other words, when entering the building BD as illustrated in (b) of FIG. 9, the delivery robot 100 may enter the entrance ER while moving below the reference speed. Here, the reference speed may be set to be below a speed when driving in the outdoor zone OZ. For instance, when the speed when driving in the outdoor zone OZ is 3 [m/s], the delivery robot 100 may pass through the entrance ER at a speed below 2 [m/s].

Meanwhile, the controller 130 may control the delivery robot 100 to drive within a region of the building according to the region information. Accordingly, while driving in the building, the delivery robot 100 may perform search driving (P2) in the region of the building according to the region information. In other words, the delivery robot 100 may perform search driving (P2) on each floor corresponding to the region of the building BD as illustrated in (c) and (d) of FIG. 9. At this time, the delivery robot 100 may perform search driving (P2) while sensing and photographing the surroundings using one or more of the sensing of the sensing unit 134 and the photographing of the photographing unit 135. For instance, while driving in the building BD, the delivery robot 100 may perform search driving (P2) while recognizing an inside of the building BD based on one or more of a sensing result of the sensing unit 134 and a photographing result of the photographing unit 135.

The controller 130 may recognize a floor of the address location based on the identification information to move to the recognized floor, and then control a location corresponding to the identification information to be searched based on one or more of the sensing result of the sensing unit 134 and the photographing result of the photographing unit 135. Here, the identification information may include information on the floor and number of the address location. In other words, the delivery robot 100 may recognize the information on the floor and number of the address location included in the identification information while performing the search driving (P2) in the building BD to move to the floor where the address location is located, and then perform search driving (P2) for the number corresponding to the address location based on one or more of the sensing result of the sensing unit 134 and the photographing result of the photographing unit 135. For instance, when the address location is “No. 303”, the delivery robot 100 may drive on the first floor 1F of the building BD, and then recognize the floor and number of the address location based on the identification information as illustrated in (c) of FIG. 9, and move to the third floor 3F of the building BD where the address location is located to search for the location of “No. 303” corresponding to the address location as illustrated in (d) of FIG. 9.

When performing search driving for a location corresponding to the address location based on the identification information, the controller 130 may recognize an identification tag attached to a door or a periphery of the address location by at least one of the sensing unit 134 and the photographing unit 135 to control a location corresponding to the identification information to be searched for. In other words, the delivery robot 100 may recognize the identification tag attached to the door or the periphery of the address location through one or more of the sensing and the photographing to search for a location corresponding to the address location as illustrated in (e) of FIG. 9.

On the other hand, when moving to the floor of the address location, the controller 130 may search for mobile equipment provided in the building using a photographing result of the photographing unit 135 to control the delivery robot 100 to move to the floor of the address location through the mobile equipment. Here, the mobile equipment may include one or more of an escalator and an elevator. In other words, when moving to the floor of the address location, the delivery robot 100 may search for one or more mobile equipment among escalators ECs and elevators EVs provided in the building BD through the photographing unit 135 to move to the floor of the address location through the mobile equipment as illustrated in (c) of FIG. 9. For instance, the delivery robot 100 may search for an elevator EV on the first floor 1F as illustrated in (c) of FIG. 9, and move to the third floor 3F using the elevator EV as illustrated in (d) of FIG. 9. In this case, the controller 130 may control the delivery robot 100 to ride on the mobile equipment according to a preset operation reference, and to operate according to the operation reference while moving through the mobile equipment. In other words, when moving through the mobile equipment, the delivery robot 100 may ride on the mobile equipment according to the operation reference and operate according to the operation reference while moving through the mobile equipment.

Subsequent to performing search driving as described above, the controller 130 may analyze one or more movement paths to the address location based on the address information, the driving path, the sensing result, and the photographing result, and generate the path information according to the analysis result. Here, the path information may include at least one of a shortest distance path from the entrance of the building to the address location and a shortest time path from the entrance door of the building to the address location. In other words, the delivery robot 100 may analyze the movement path to determine at least one of a path corresponding to the shortest distance from the entrance of the building to the address location, and a path corresponding to the shortest time from the entrance of the building to the address location based on the address information, the driving path, the sensing result, and the photographing result, and generate the path information (P3) according to the analysis result. Accordingly, the path information includes at least one of a shortest distance path and a shortest time path to allow the delivery robot 100 to drive to the address location according to either one of the shortest distance path and the shortest time path when driving again to the address location later.

Subsequent to generating the path information as described above, the controller 130 may store the path information in the storage unit 136. In other words, the delivery robot 100 may store the path information (P3-1) to drive to the address location based on the path information when driving to the address location later. Furthermore, the controller 130 may transmit the path information to the control server 200. In other words, the delivery robot 100 may transmit the path information to the control server 200 to allow the control server 200 to store the path information (P3-2).

In addition, the controller 130 may further generate structure information on each floor structure of the building based on the address information, the driving path, the sensing result, and the photographing result. In other words, subsequent to generating the path information (P3), the delivery robot 100 may further generate the structure information on each floor structure of the building BD. Here, the structure information may be information on a structure inside the building BD that the delivery robot 100 has searched for while driving. Accordingly, when driving to the building BD later, the delivery robot 100 may drive based on the structure information, thereby reducing a search driving time for the building BD, a movement time to the address location, and a generation time of the path information. Furthermore, the controller 130 may store the structure information in the storage unit 136. In other words, the delivery robot 100 may store the structure information (P4-1), and drive to the address location based on the structure information when driving to the address location later. In addition, the controller 130 may transmit the structure information to the control server 200. In other words, the delivery robot 100 may transmit the structure information to the control server 200 to allow the control server 200 to store the structure information (P4-2).

Furthermore, the controller 130 may generate map information of the building based on the path information and the structure information, or update previously generated map information. In other words, subsequent to generating the structure information (P4), the delivery robot 100 may further generate the map information (P5) or update (store) the previously generated map information (P5-1). Here, the map information may refer to information including an overall structure of the building and a movement path to each room in the building. Furthermore, the controller 130 may store the structure information in the storage unit 136. In other words, the delivery robot 100 may store the map information (P5-1), and drive to the address location based on the map information when driving to the address location later. Furthermore, the controller 130 may transmit the map information to the control server 200. In other words, the delivery robot 100 may transmit the map information to the control server 200 to allow the control server 200 to store the map information (P5-2).

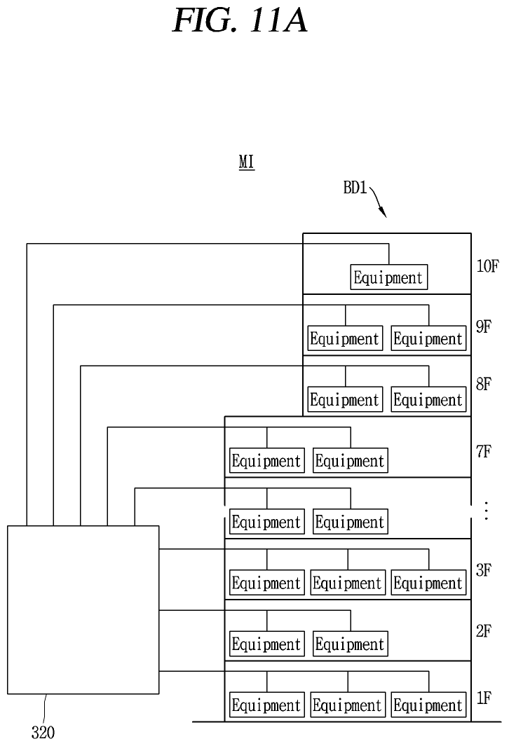

An illustration of a specific delivery driving according to the embodiment of the delivery robot 100 may be implemented as illustrated in FIG. 10.

When the delivery robot 100 receives a movement command to a destination and address information of the destination from the control server 200, the driving of the delivery robot 100 may be started. At this time, a product to be delivered to the destination may be loaded in the loading unit 110 at a predetermined point, and then delivery driving to the destination may be started. The delivery robot 100 may move to a building corresponding to the destination based on the address information to enter the building (S1). When the floor of the destination is not the first floor as a result of recognizing the floor and number of the destination based on the address information, the controller 130 may perform search driving (S2) for one or more mobile equipment among elevators and escalators in the building based on a sensing result of the sensing unit 134 and a photographing result of the photographing unit 135, that is, based on Vision AI, and ride on the searched mobile equipment (S3) to perform movement to the floor corresponding to the destination. In case of riding on an elevator, the delivery robot 100 may enter a number of the destination floor, and then get off the elevator (S4) upon arrival at the number of the destination floor to perform search driving (S5) for a room corresponding to the number of the destination based on Vision AI. In this case, the delivery robot 100 may recognize an identification tag attached to the door or the periphery of the destination, thereby searching for a room corresponding to the destination. Upon arrival at the destination (S6) through the foregoing process, loaded products may be unloaded and delivered to the destination (S7), and then returned to an exit of the building (S8) to complete the delivery.

The delivery system 10000 as a system in which the delivery robot 100 as described above performs delivery includes the control server 200 that controls the delivery system 10000, the communication device 300 that communicates with a plurality of communication targets in the driving region, and the delivery robot 100 that performs delivery while driving in the driving region according to communication with the control server 200 and the communication device 300 as illustrated in FIG. 1. Here, communication may be connected between the delivery robot 100 and the control server 200 through the communication network 400, and communication may be connected between the delivery robot 100 and the communication device 300, and between the control server 200 and the communication device 300 using the communication network 400 and one or more of additional communication networks other than the communication network 400. The delivery system 10000 may refer to a delivery service system or a system applied to a delivery service. In addition, when delivery is carried out only in a specific building, the delivery system 10000 may refer to a management system of the specific building or a system applied to the management system.

In the delivery system 10000, the control server 200 may be a management server of a service company that provides a delivery service in the delivery system 10000. Furthermore, the control server 200 may be a management server of a communication company that provides the communication network 400. The control server 200 may refer to a server or a central controller that controls the delivery robot 100 while communicating with one or more communication targets including the delivery robot 100 in the delivery system 10000 irrespective of the type of service provided and the service company. Here, the control of the control server 200 may refer to transmitting and receiving data while communicating with a communication target, monitoring the state of the communication target, and (remotely) controlling the communication target. In other words, the control server 200 may be a central control server of the delivery system 10000. For instance, upon receiving a delivery request, the control server 200 may generate an operation command for the delivery request and transmits the operation command to the delivery robot 100, and the delivery robot 100 may start driving for delivery according to the received operation command. In this case, the control server 200 may receive the location of the delivery robot 100 in movement from the delivery robot 100 or another device that tracks the location of the delivery robot 100, such as a GPS device or a base station device of the communication company to recognize the location of the delivery robot 100 and control the operation of the delivery robot 100.

In the delivery system 10000, the communication device 300 as a device capable of communicating with the delivery robot 100 may be a device that provides driving-related information to the delivery robot 100. There may be one or more communication devices 300, and when the communication device 300 includes a plurality of devices of different types, each device may communicate with the delivery robot 100. In this case, each of the plurality of devices may provide different information to the delivery robot 100. The type of the communication device 300 may include at least one of the foregoing examples, and may further include all devices capable of communicating with the delivery robot 100 in addition to the foregoing examples.

In the delivery system 10000 including the control server 200, the communication device 300, and the delivery robot 100, the delivery robot 100 receives the address information of an address location where path information is not stored from the control server 200 to move to a building corresponding to the address location based on the address information, and receives search information on the address location from one or more of the control server 200 and the communication device 300 to drive while searching for the address location in the building based on the address information and the search information, and generates path information of the address location based on the driving result to perform one or more of storing the path information and transmitting the path information to the control server 200. In other words, the delivery robot 100 may perform search driving in the building based on the address information and the search information, and generate the path information based on the driving result. Here, the address information may include the identification information of the address location, the location information of a building corresponding to the address location, and the region information on a region of the building, and the search information as information on an inside of the building generated by the communication device 300 may include, for instance, information on the structure, arrangement, shape, equipment status, and rooms of the building. The search information may be directly transmitted to the delivery robot 100 by the communication device 300, or may be transmitted to the control server 200 and provided to the delivery robot 100 by the control server 200. The search information may be information serving as a basis for generating structure information that allows the delivery robot 100 to recognize the structure of the building. In other words, the delivery robot 100 may generate the structure information of the building based on the search information to drive in the building based on the address information and the structure information. Here, the search information and the structure information may be classified according to a format of data, a type of information included therein, and an arrangement method, and the like. For instance, the structure information may be information obtained by allowing the controller 130 to process or convert the search information into a recognizable form of the structure of the building in the controller 130. Furthermore, the structure information may refer to information generated according to a filtering result when the controller 130 filters information necessary for recognizing the structure of the building from the search information.

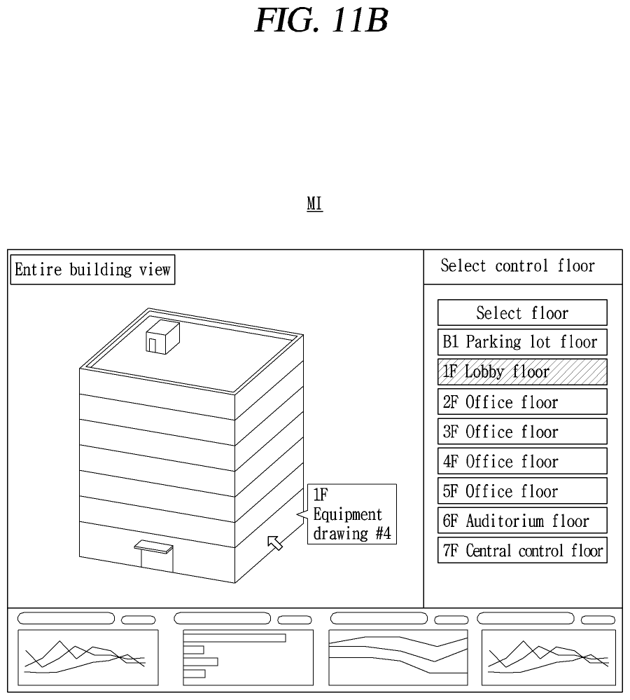

In the delivery system 10000 in which the delivery robot 100 generates the structure information based on the search information, the communication device 300 is a control device (server) for centrally controlling energy use equipment provided in the building, and the search information may include installation information of the energy use equipment. In this case, the communication device 300 may be a building management system (BMS) device (server) that controls energy use of the building, and the search information may be BMS information of the building. In addition, the communication device 300 is a communication server communicably connected to communication equipment provided in the building, and the search information may include installation information of the communication equipment. In this case, the communication device 300 may be a server of a communication company that manages the communication network 400 in the building, and the search information may be network management information of the communication company. As such, the search information may include the installation information of equipment provided in the building, thereby allowing the controller 130 to recognize the floor and room of the building based on the installation information. For instance, as shown in FIGS. 11A and 11B, installation information on the installation location of air conditioning equipment provided in each floor and each room and/or installation information (MI) on the installation location of communication modules (Wi-Fi modules) provided in each floor and each room may be included in the search information. Accordingly, the delivery robot 100 may recognize the location of a room in the building according to the installation locations of the energy use equipment and/or the communication equipment through the search information, thereby recognizing the structure of the building to generate the structure information, and driving in the building while recognizing the structure of the building according to the structure information.

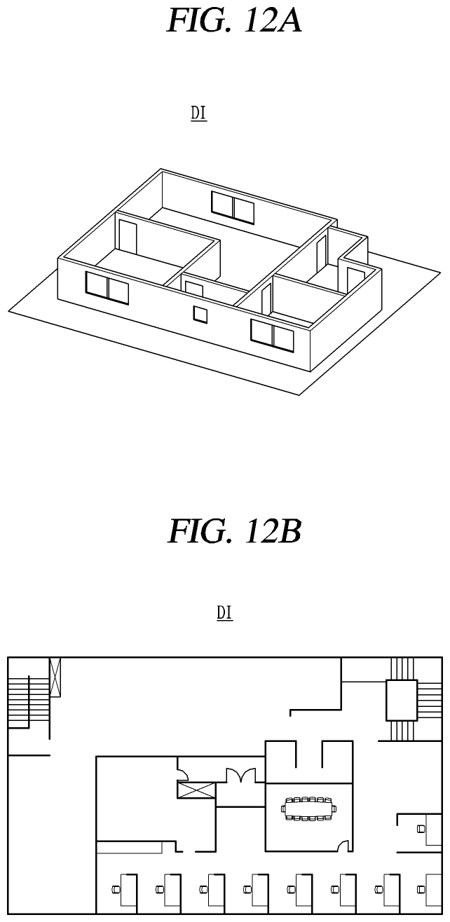

In addition, the communication device 300 may be a central server of at least one of a construction company and a management company of the building, and the search information may include design information of the building. For instance, the design information DI of the building as illustrated in FIGS. 12A and 12B may be included in the search information. Accordingly, the delivery robot 100 may recognize the location of each floor and each room according to the design information (DI) of the building through the search information, thereby recognizing the structure of the building to generate the structure information, and driving in the building while recognizing the structure of the building according to the structure information.

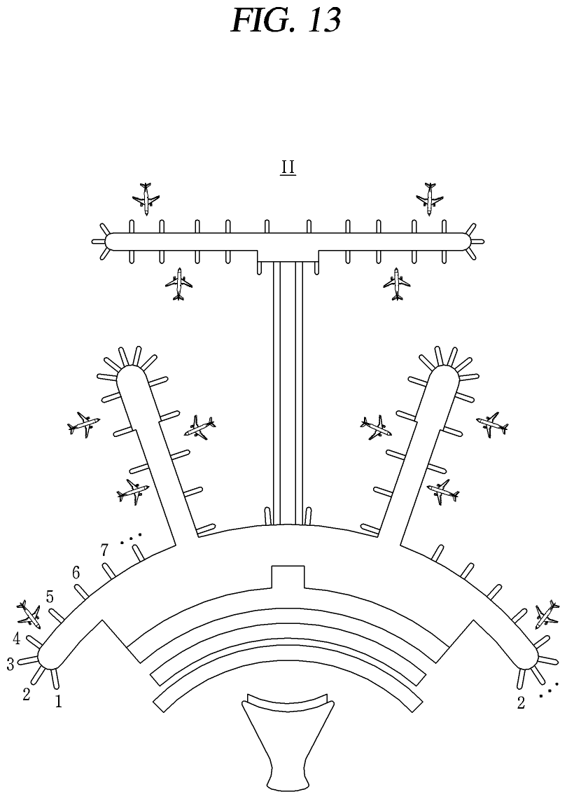

Furthermore, the communication device 300 may be a central server of a user company of the building, and the search information may include guide information of the building. For example, when the building is a shopping mall, the communication device 300 is a central server of the shopping mall, and the guide information may include map information on each floor of the shopping mall. Alternatively, when the building is an office building of LZ Corporation, the communication device 300 may be a central server of the LZ Corporation, and the guide information may include map information on each floor of the office building. Alternatively, when the building is an airport and the communication device 300 is a guide server of the airport, an airport guide map II as shown in FIG. 13 may be included in the search information. Accordingly, the delivery robot 100 may recognize the location of each floor and each room according to the guide information (II) of the building through the search information, thereby recognizing the structure of the building to generate the structure information, and driving in the building while recognizing the structure of the building according to the structure information.

A process in which the delivery robot 100 drives in the delivery system 10000 may be carried out by a process as illustrated in FIG. 9 described above.

When the delivery robot 100 receives the movement command and the address information from the control server 200, the delivery robot 100 may move to the building BD as illustrated in (a) of FIG. 9. In this case, the delivery robot 100 may move to the building BD based on the location information included in the address information.

The delivery robot 100 may move to the building BD, and then enter the building BD through the entrance ER of the building BD as illustrated in (b) of FIG. 9. In this case, the delivery robot 100 may pass through the entrance ER while moving below the reference speed.

The delivery robot 100 may enter the building BD, and then perform search driving in the building BD as illustrated in (c) and (d) of FIG. 9 based on the address information and the search information. In this case, the delivery robot 100 may search for a structure in the building BD and a location corresponding to the address location while driving in a region of the building BD based on the identification information and the region information included in the address information, and the structure information generated based on the search information.

On the other hand, when moving to the floor of the address location, the delivery robot 100 may search for mobile equipment provided in the building using a photographing result of the photographing unit 135 to move to the floor of the address location through the mobile equipment. In other words, when moving to the floor of the address location, the delivery robot 100 may search for one or more mobile equipment among escalators ECs and elevators EVs provided in the building BD through the photographing unit 135 to move to the floor of the address location through the mobile equipment as illustrated in (c) of FIG. 9. For instance, the delivery robot 100 may search for an elevator EV on the first floor 1F as illustrated in (c) of FIG. 9, and move to the third floor 3F using the elevator EV as illustrated in (d) of FIG. 9. In this case, the delivery robot 100 may ride on the mobile equipment according to a preset operation reference, and operate according to the operation reference while moving through the mobile equipment.

The delivery robot 100 may move to the floor of the address location, and then search for a location corresponding to the address location based on one or more of the sensing result of the sensing unit 134 and the photographing result of the photographing unit 135 as illustrated in (e) of FIG. 9. In this case, the delivery robot 100 may search for a location corresponding to the address location based on the identification information.

Subsequent to completing search driving as illustrated in FIG. 9, the delivery robot 100 may perform one or more of storing of the path information and transmitting the path information to the control server 200 based on the driving result. In other words, the delivery robot 100 may store the path information in the storage unit 136 or transmit the path information to the control server 200. Accordingly, when driving again in the building later, the delivery robot 100 may drive in the building based on the path information. Furthermore, the delivery robot 100 may generate the structure information based on the address information and the path information or update pre-stored structure information. In other words, when the structure information is not stored, the delivery robot 100 may generate the structure information based on the address information and the path information to store the structure information in the storage unit 136 or transmit the structure information to the control server 200, and reflect the structure information generated based on the address information and the path information in structure information pre-stored in the storage unit 136 or transmit the structure information to the control server 200. In addition, the delivery robot 100 may return to the entrance ER or perform a subsequent operation.

On the other hand, according to another embodiment of the delivery system 10000, the control server 200 generates the structure information and provides the generated structure information to the delivery robot 100. In other words, the delivery robot 100 in the delivery system 10000 performs one or more of receiving the address information of an address location where path information is not stored and the structure information of a building corresponding to the address location from the control server 200 to move to the building corresponding to the address location based on the address information, driving while searching for the address location in the building based on the address information and the structure information, and generating the path information of the address location based on the driving result to store the path information and transmit the path information to the control server 200. In this case, the delivery robot 100 performs one or more of receiving the address information and the structure information from the control server 200 to move to the building based on the address information, and driving while searching for the address location in the building based on the address information and the structure information, and generating the path information based on the driving result to store the path information and transmit the path information to the control server 200.

In the foregoing embodiment, the control server 200 may receive the search information from one or more of the communication device 300 and the delivery robot 100 to generate the structure information based on the search information, and transmit the structure information to the delivery robot 100. In other words, the generation of the structure information may be carried out in the control server 200. The structure information may be generated by the control server 200 as described above to allow data calculation and processing such as generation of the structure information to be carried out by the control server 200, thereby reducing data calculation and throughput by the delivery robot 100. Accordingly, a configuration for data calculation and processing of the delivery robot 100 may be simplified, and data may be processed by the control server 200, thereby increasing the security of the delivery system 10000.

Even in the delivery system 10000 as described above, the communication device 300 is a control device (server) for centrally controlling energy use equipment provided in the building, and the search information may include installation information of the energy use equipment. In this case, the communication device 300 may be a building management system (BMS) device (server) that controls energy use of the building, and the search information may be BMS information of the building. In addition, the communication device 300 is a communication server communicably connected to communication equipment provided in the building, and the search information may include installation information of the communication equipment. In this case, the communication device 300 may be a server of a communication company that manages the communication network 400 in the building, and the search information may be network management information of the communication company. As such, the search information may include the installation information (MI) of equipment provided in the building as illustrated 11A and 11B, thereby allowing the controller 130 to recognize the floor and room of the building based on the installation information (MI). In addition, the communication device 300 may be a central server of at least one of a construction company and a management company of the building, and the search information may include design information of the building. For instance, the design information DI of the building as illustrated in FIGS. 12A and 12B may be included in the search information. Furthermore, the communication device 300 may be a central server of a user company of the building, and the search information may include guide information of the building. For instance, the guide information II of the building as illustrated in FIG. 13 may be included in the search information.

The foregoing search information may be generated by the communication device 300 and transmitted to one or more of the control server 200 and the delivery robot 100. For instance, the search information may be directly transmitted to the control server 200 or may be transmitted to the delivery robot 100 by the communication device 300, and transmitted to the control server 200 by the delivery robot 100.

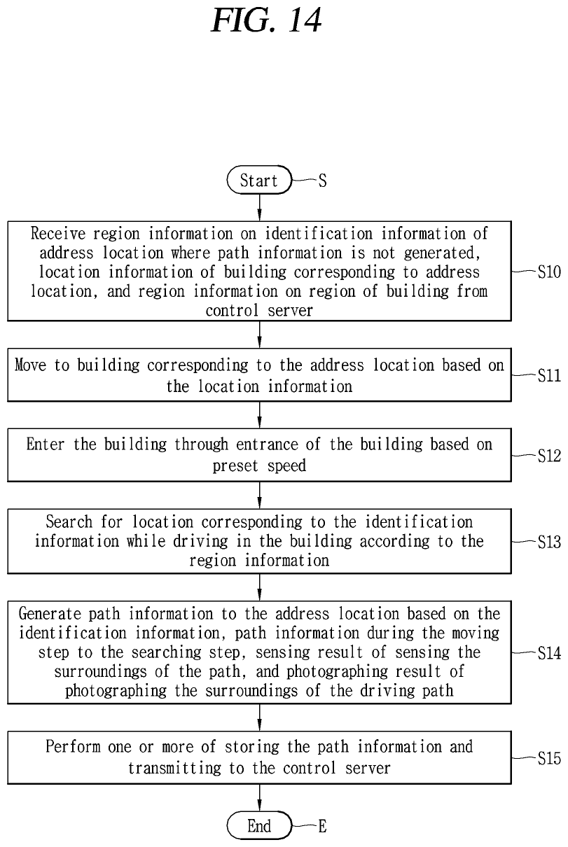

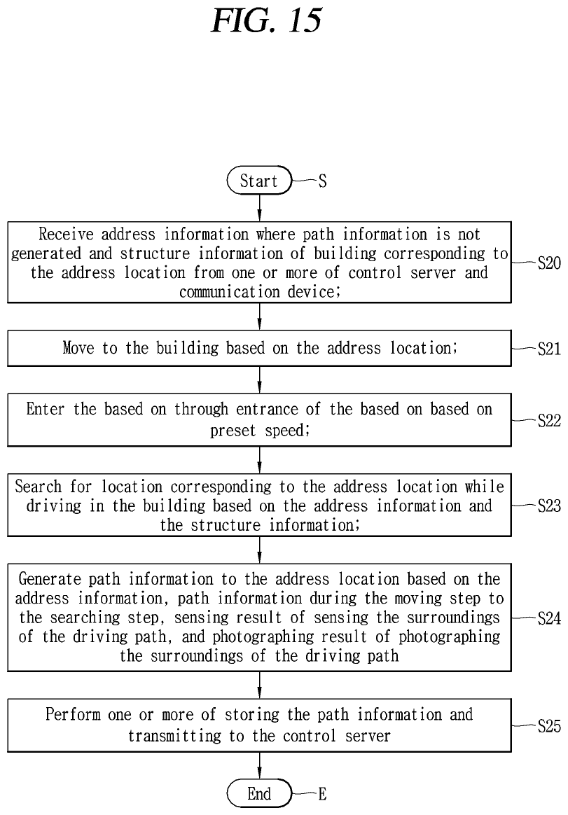

In a specific embodiment of the delivery system 10000 as described above, a driving method of the delivery robot 100 may be carried out in the order as illustrated in FIG. 14 or FIG. 15.

The driving method as a driving method of the delivery robot 100 that drives in a driving region including one or more of an outdoor region and an indoor region in the delivery system 10000 may be a method applied to the delivery robot 100 and the delivery system 10000 described above. In addition, the driving method may be implemented as an independent embodiment separate from the embodiments of the delivery robot 100 and the delivery system 10000 described above.

As illustrated in FIG. 14, the driving method includes receiving the identification information, the location information, and the region information from the control server 200 that controls the delivery robot 100 (S10), moving to a building corresponding to the address location based on the location information (S11), entering the building through an entrance of the building based on a preset speed (S12), searching for a location corresponding to the identification information while driving in the building according to the region information (S13), and generating the path information based on the identification information, a driving path during the moving step (S11) to the searching step (S13), and a sensing result of sensing the surroundings of the driving path, and a photographing result of photographing the surroundings of the driving path (S14). In other words, the delivery robot 100 may operate in the order of receiving the identification information, the location information, and the region information from the control server 200 (S10), moving to a building corresponding to the address location based on the location information (S11), entering the building through an entrance of the building based on a preset speed (S12), searching for a location corresponding to the identification information while driving in the building according to the region information, and (S13), and generating the path information based on the identification information, the driving path, the sensing result, and the photographing result (S14). Furthermore, the driving method may further include performing at least one of storing the path information and transmitting the path information to the control server 200 (S15). In other words, the delivery robot 100 may generate the path information (S14), and then store the path information in the storage unit 136 or transmit the path information to the control server 200 (S15).

In addition, as illustrated in FIG. 15, another embodiment of the driving method includes receiving the address information and the structure information from one or more of the control server 200 that controls the delivery robot 100 and the communication device 300 that performs communication in the driving region (S20), moving to the building based on the address information (S21), entering the building through an entrance door of the building based on a preset speed (S22), searching for a location corresponding to the address location while driving in the building based on the address information and the structure information (S23), and generating the path information to the address location based on the address information, a driving path during the moving step (S21) to the searching step (S23), a sensing result of sensing the surroundings of the driving path, and a photographing result of photographing the surroundings of the driving path (S24). In other words, the delivery robot 100 may operate in the order of receiving the address information and the structure information from one or more of the control server 200 and the communication device 300 (S20), moving to the building based on the address information (S21), entering the building through an entrance of the building based on a preset speed (S22), searching for a location corresponding to the address location while driving in the building based on the address information and the structure information (S23), and generating the path information to the address location based on the address information, the driving path, the sensing result, and the photographing result (S24). Moreover, the driving method may further include performing one or more of storing the path information and transmitting the path information to the control server 200. In other words, the delivery robot 100 may generate the path information (S24), and then store the path information in the storage unit 136 or transmit the path information to the control server 200 (S25).

Although specific embodiments have been described so far, it should be apparent that various modifications may be made thereto without departing from the scope of the present disclosure. Therefore, the scope of the present disclosure should not be limited to the above-described embodiments, and should be defined by the claims to be described later as well as equivalents thereto.

What is claimed is:

1. A delivery robot that drives in one or more of an outdoor region and an indoor region, the delivery robot comprising:
a communication transceiver configured to communicate with a control server;
one or more sensors configured to sense information related to a state of the delivery robot;
at least one camera configured to capture an image of surroundings of the delivery robot;
a drive part configured to move a main body of the delivery robot; and
a controller configured to:
receive address information of an address location from the control server to drive while searching for the address location in a building corresponding to the address location based on the address information, and
generate path information to the address location based on at least one of the address information, a driving path while searching for the address location, a sensing result of the one or more sensors and the image captured by the at least one camera.

2. The delivery robot of claim 1, wherein the address information comprises:
identification information of the address location, location information of a building corresponding to the address location, and region information on an region of the building.

3. The delivery robot of claim 2, wherein the controller is further configured to:
when moving from a location other than the building to the address location, move the delivery robot to the building based on the location information.

4. The delivery robot of claim 3, wherein the controller is further configured to:
when moving from outside of the building to an inside of the building, control the drive part to move the delivery robot to enter an entrance of the building while moving below a preset reference speed.

5. The delivery robot of claim 4, wherein the reference speed is less than a speed for driving in the outdoor region.

6. The delivery robot of claim 2, wherein the controller is further configured to control the delivery robot to drive in a region of the building based on the region information.

7. The delivery robot of claim 2, wherein the controller is further configured to:
recognize a floor of the address location based on the identification information to move the delivery robot to the recognized floor, and
search for a location corresponding to the identification information based on one or more of the sensing result and the image.

8. The delivery robot of claim 7, wherein the identification information comprises information on the floor and a number of the address location.

9. The delivery robot of claim 8, wherein the controller is further configured to:
recognize an identification tag attached to a door or a periphery of the address location based on the sensing results or the image when searching for the location corresponding to the identification information.

10. The delivery robot of claim 7, wherein the controller is further configured to:
search for mobile equipment provided in the building based on the image while moving toward the floor of the address location.

11. The delivery robot of claim 10, wherein the mobile equipment comprises at least one of an escalator and an elevator.

12. The delivery robot of claim 10, wherein the controller is further configured to:
control the delivery robot to ride on the mobile equipment based on a preset operation reference and operate based on the operation reference while moving through or along the mobile equipment.

13. The delivery robot of claim 1, wherein the controller is further configured to:
analyze one or more movement paths to the address location based on the address information, the driving path, the sensing result, and the photographing result to generate an analysis results, and
generate the path information according to the analysis result.

14. The delivery robot of claim 13, wherein the path information comprises at least one of a shortest distance path from an entrance of the building to the address location and a shortest time path from an entrance door of the building to the address location.

15. The delivery robot of claim 1, wherein the controller is further configured to:
generate structure information on at least one floor structure of the building based on the address information, the driving path, the sensing result, and the image.

16. The delivery robot of claim 15, wherein the controller is further configured to:
generate map information of the building based on the path information and the structure information, or update previously generated map information based on the path information and the structure information.

17. A method of controlling a delivery robot that drives in a driving region comprising one or more of an outdoor region and an indoor region, the method comprising:
receiving, by a communication device in the delivery robot, at least one of identification information of an address location, location information of a building corresponding to the address location, and region information on a region of the building from a control server;
controlling a driving part in the delivery robot to move the delivery robot to a building corresponding to the address location based on the location information;
entering the building through an entrance of the building based on a preset speed;
searching, by the delivery robot, for a location corresponding to the identification information while driving in the building according to the region information; and
generating, by the delivery robot, path information to the address location based on at least one of the identification information, a driving path, a sensing result of sensing the surroundings of the driving path, and a photographing result of photographing the surroundings of the driving path.

18. A method of controlling a delivery robot that drives in a driving region comprising one or more of an outdoor region and an indoor region, the method comprising:
receiving, by a communication device in the delivery robot, address information of an address location and structure information of a building corresponding to the address location from one or more of a control server and a communication device that performs communication in the driving region;
controlling a driving part in the delivery robot to move the delivery robot to the building based on the address information;
entering the building through an entrance of the building based on a preset speed;
searching, by the delivery robot, for a location corresponding to the address location while driving in the building based on the address information and the structure information; and
generating, by the delivery robot, path information to the address location based on at least one of the address information, a driving path, a sensing result of sensing the surroundings of the driving path, and a photographing result of photographing the surroundings of the driving path.
